(19) United States
(12) Patent Application Publication
(10) Pub. No.: US 2024/0253632 A1
(43) Pub. Date: Aug. 1, 2024

(54) VEHICLE DRIVING ASSISTANCE APPARATUS, VEHICLE DRIVING ASSISTANCE METHOD, AND COMPUTER-READABLE STORAGE MEDIUM STORING VEHICLE DRIVING ASSISTANCE PROGRAM

(71) Applicant: TOYOTA JIDOSHA KABUSHIKI KAISHA, Toyota-shi (JP)

(72) Inventors: Hideki KAMATANI, Nagoya-shi (JP); Takahiro Narita, Tokyo (JP)

(73) Assignee: TOYOTA JIDOSHA KABUSHIKI KAISHA, Toyota-shi (JP)

(21) Appl. No.: 18/424,338

(22) Filed: Jan. 26, 2024

(30) Foreign Application Priority Data
Jan. 31, 2023 (JP) 2023-012903

(51) Int. Cl. B60W 30/165; B60W 30/14; B60W 30/182; B60W 50/02; B60W 50/029; B60W 60/00

(52) U.S. Cl. CPC B60W 30/165; B60W 30/143; B60W 30/182; B60W 50/0205; B60W 50/029; B60W 60/001; B60W 2050/021; B60W 2554/802

(57) ABSTRACT

A vehicle driving assistance apparatus, while executing a vehicle moving speed increasing/decreasing control, sets a set vehicle moving speed range such that the set vehicle moving speed range set when a control range change condition is satisfied, is narrower than the set vehicle moving speed range set when the control range change condition is unsatisfied, and while executing an inter-vehicle distance increasing/decreasing control, sets the set inter-vehicle distance range such that the set inter-vehicle distance range set when the control range change condition is satisfied, is narrower than the set inter-vehicle distance range set when the control range change condition is unsatisfied.

### CROSS-REFERENCE TO RELATED APPLICATIONS

This application claims priority to Japanese patent application No. JP 2023-012903 filed on Jan. 31, 2023, the content of which is hereby incorporated by reference in its entirety.

### BACKGROUND

### Field

The present invention relates to a vehicle driving assistance apparatus, a vehicle driving assistance method, and a computer-readable storage medium storing a vehicle driving assistance program.

### Description of the Related Art

There is known a vehicle driving assistance apparatus which executes an autonomous moving control of moving an own vehicle by autonomously controlling activations of a power apparatus of the own vehicle such that a vehicle moving speed of the own vehicle alternately increases and decreases within a set vehicle speed range, or an inter-vehicle distance between the own vehicle and a preceding vehicle alternately increases and decreases within a set inter-vehicle distance range (for example, refer to JP 2022-95320 A). The known vehicle driving assistance apparatus reduces a consumed energy amount, i.e., an amount of energy consumed by the power apparatus for moving the own vehicle by the autonomous moving control.

When the vehicle moving speed of the own vehicle is alternately increased and decreased excessively, or the inter-vehicle distance between the own vehicle and the preceding vehicle is alternately increased and decreased excessively by the autonomous moving control in a situation where a following vehicle exists, a vehicle moving speed of the following vehicle alternately increases and decreases considerably. As a result, it may disrupt smooth traffic of vehicles including the following vehicle around the own vehicle. Therefore, in order to maintain the smooth traffic of the vehicles around the own vehicle, the autonomous moving control should be executed in consideration of the following vehicle.

To this end, the following vehicle needs to be detected by a detection device which detects the following vehicle. In this regard, when the following vehicle cannot be detected by the detection device due to a malfunction of the detection device, the following vehicle cannot be considered while the autonomous moving control is being executed. As a result, the autonomous moving control cannot be executed so as to maintain the smooth traffic of the vehicles around the own vehicle.

### SUMMARY

An object of the present invention is to provide a vehicle driving assistance apparatus, a vehicle driving assistance method, and a computer-readable storage medium storing a vehicle driving assistance program which can move the own vehicle autonomously by the autonomous moving control without disrupting the smooth traffic of the vehicles around the own vehicle even when the following vehicle cannot be detected.

A vehicle driving assistance apparatus according to the present invention comprises an electronic control unit which is configured to execute at least one of a vehicle moving speed increasing/decreasing control and an inter-vehicle distance increasing/decreasing control. The vehicle moving speed control corresponds to a control of autonomously moving an own vehicle while alternately increasing and decreasing a vehicle moving speed of the own vehicle within a set vehicle moving speed range. The inter-vehicle distance increasing/decreasing control corresponds to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range. The electronic control unit is configured to, while executing the vehicle moving speed increasing/decreasing control, set the set vehicle moving speed range such that the set vehicle moving speed range set when a control range change condition is satisfied, is narrower than the set vehicle moving speed range set when the control range change condition is unsatisfied. The control range change condition corresponds to a condition that a following vehicle detection device which detects a following vehicle, is malfunctioning. In addition, the electronic control unit is configured to, while executing the inter-vehicle distance increasing/decreasing control, set the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.

When the vehicle moving speed of the own vehicle alternately and excessively increases and decreases, or the inter-vehicle distance between the own vehicle and the other vehicle around the own vehicle alternately and excessively increases and decreases in a situation where (i) the own vehicle is autonomously moved by the vehicle moving speed increasing/decreasing control or the inter-vehicle distance increasing/decreasing control, and (ii) the following vehicle exists, the following vehicle alternately and considerably increases and decreases its vehicle moving speed. As a result, the smooth traffic of the vehicles around the own vehicle may be disrupted. Therefore, in order to maintain the smooth traffic of the vehicles around the own vehicle, the own vehicle should be autonomously moved by the vehicle moving speed increasing/decreasing control or the inter-vehicle distance increasing/decreasing control in consideration of an existence of the following vehicle. To this end, the following vehicle detection device needs to detect the following vehicle. However, when the following vehicle detection device cannot detect the following vehicle due to its malfunction, the vehicle moving speed increasing/decreasing control or the inter-vehicle distance increasing/decreasing control cannot be executed in consideration of the existence of the following vehicle. Thereby, the own vehicle cannot be autonomously moved by the vehicle moving speed increasing/decreasing control or the inter-vehicle distance increasing/decreasing control so as to maintain the smooth traffic of the vehicles around the own vehicle.

With the vehicle driving assistance apparatus according to the present invention, the set vehicle moving speed range or the set inter-vehicle distance range is narrow when the following vehicle detection device is malfunctioning, compared with when the following vehicle detection device is normally functioning. Thereby, the vehicle moving speed of the own vehicle or the inter-vehicle distance between the own vehicle and the other vehicle around the own vehicle is maintained within a narrow range. Thus, the vehicle moving speed of the own vehicle or the inter-vehicle distance between the own vehicle and the other vehicle, can be prevented from alternately and excessively increasing or decreasing. Therefore, the own vehicle can be autonomously moved by the autonomous moving control (i.e., the vehicle moving speed increasing/decreasing control or the inter-vehicle distance increasing/decreasing control) without disrupting the smooth traffic of the vehicles around the own vehicle when the following vehicle cannot be detected.

In the vehicle driving assistance apparatus according to an aspect of the present invention, the electronic control unit may be configured to execute at least one of a vehicle moving speed maintaining control and an inter-vehicle distance maintaining control. The vehicle moving speed maintaining control may correspond to a control of autonomously moving the own vehicle while maintaining the vehicle moving speed at a set vehicle moving speed. The inter-vehicle distance maintaining control may correspond to a control of autonomously moving the own vehicle while maintaining the inter-vehicle distance at a set inter-vehicle distance or maintaining the period of time required for the own vehicle to move the inter-vehicle distance at a set period of time. In addition, the electronic control unit may be configured to, when a moving mode change condition becomes satisfied while executing the vehicle moving speed increasing/decreasing control, stop executing the vehicle moving speed increasing/decreasing control and execute the vehicle moving speed maintaining control. The moving mode change condition may corresponds to a condition that (i) the following vehicle detection device normally functions, (ii) the following vehicle is detected, and (iii) a distance between the detected following vehicle and the own vehicle is equal to or smaller than a predetermined distance, or a period of time required for the detected following vehicle to move the distance between the detected following vehicle and the own vehicle, is equal to or smaller than a predetermined period of time. In addition, the electronic control unit may be configured to, when the moving mode change condition becomes satisfied while executing the inter-vehicle distance increasing/decreasing control, stop executing the inter-vehicle distance increasing/decreasing control and execute the inter-vehicle distance maintaining control.

When the vehicle moving speed of the own vehicle alternately and excessively increases and decreases, or the inter-vehicle distance between the own vehicle and the other vehicle around the own vehicle alternately and excessively increases and decreases in a situation where (i) the own vehicle is autonomously moved by the vehicle moving speed increasing/decreasing control or the inter-vehicle distance increasing/decreasing control, and (ii) the following vehicle exists, the following vehicle alternately and considerably increases and decreases its vehicle moving speed. As a result, the smooth traffic of the vehicles around the own vehicle may be disrupted.

With the vehicle driving assistance apparatus according to this aspect of the present invention, when the following vehicle exists relatively near the own vehicle, i.e., when the moving mode change condition becomes satisfied, an execution of the vehicle moving speed increasing/decreasing control or the inter-vehicle distance increasing/decreasing control is stopped, and the vehicle moving speed maintaining control or the inter-vehicle distance maintaining control is executed. Thereby, the vehicle moving speed of the own vehicle or the inter-vehicle distance between the own vehicle and the other vehicle around the own vehicle is maintained constant. Therefore, the own vehicle can be autonomously moved without disrupting the smooth traffic of the vehicles around the own vehicle when the following vehicle exists relatively near the own vehicle.

In the vehicle driving assistance apparatus according to another aspect of the present invention, the electronic control unit may be configured to execute at least one of the vehicle moving speed increasing/decreasing control and the inter-vehicle distance increasing/decreasing control at any of a first driving mode and a second driving mode. The first driving mode may correspond to a mode of moving the own vehicle by activating both of an internal combustion engine and an electric motor or by activating the internal combustion engine only to apply a power to the own vehicle. The second driving mode may correspond to a mode of moving the own vehicle by activating the electric motor only to apply the power to the own vehicle. The set vehicle moving speed range set when the vehicle moving speed increasing/decreasing control is executed at the second driving mode, may be narrower than the set vehicle moving speed range set when the vehicle moving speed increasing/decreasing control is executed at the first driving mode. The set inter-vehicle distance range set when the inter-vehicle distance increasing/decreasing control is executed at the second driving mode, may be narrower than the set inter-vehicle distance range set when the inter-vehicle distance increasing/decreasing control is executed at the first driving mode. The control range change condition may include a condition that the vehicle moving speed increasing/decreasing control or the inter-vehicle distance increasing/decreasing control is executed at the first driving mode. In addition, the electronic control unit may be configured not to change the set vehicle moving speed range or the set inter-vehicle distance range or the set period-of-time range even when the control range change condition becomes satisfied while executing the vehicle moving speed increasing/decreasing control or the inter-vehicle distance increasing/decreasing control at the second driving mode.

With the vehicle driving assistance apparatus according to this aspect of the present invention, when the own vehicle is autonomously moved by the vehicle moving speed increasing/decreasing control or the inter-vehicle distance increasing/decreasing control at the second driving mode, the set vehicle moving speed range or the set inter-vehicle distance range is relatively narrow. Therefore, the vehicle moving speed of the own vehicle or the inter-vehicle distance between the own vehicle and the other vehicle around the own vehicle does not alternately and considerably increase and decrease even when the own vehicle continues being moved by the vehicle moving speed increasing/decreasing control or the inter-vehicle distance increasing/decreasing control without changing the set vehicle moving speed range or the set inter-vehicle distance range in a situation where the following vehicle cannot be detected due to the malfunction of the following vehicle detection device. Therefore, the following vehicle does not change its vehicle moving speed considerably. Thus, there is a low possibility of disrupting the smooth traffic of the vehicles around the own vehicle. Therefore, the vehicle driving assistance apparatus can move the own vehicle autonomously by the vehicle moving speed increasing/decreasing control or the inter-vehicle distance increasing/decreasing control while maintaining the smooth traffic of the vehicles around the own vehicle without changing the set vehicle moving speed range or the set inter-vehicle distance range.

In the vehicle driving assistance apparatus according to further another aspect of the present invention, the electronic control unit may be configured to execute the vehicle moving speed increasing/decreasing control or the inter-vehicle distance increasing/decreasing control while selectively executing a power control at a first state and a power control at a second state. The first state may correspond to a state of reducing a power generation loss in a power apparatus of the own vehicle or a power transmission loss from the power apparatus to driven wheels of the own vehicle. The second state may correspond to a state of mechanically or electrically connecting the power apparatus to the driven wheels and applying the power to the driven wheels. In addition, the electronic control unit may be configured to set the set vehicle moving speed range or the set inter-vehicle distance range such that the set vehicle moving speed range or the set inter-vehicle distance range or the set period-of-time range set when autonomously moving the own vehicle by the vehicle moving speed increasing/decreasing control or the inter-vehicle distance increasing/decreasing control at the first driving mode, is broader than the set vehicle moving speed range or the set inter-vehicle distance range or the set period-of-time range set when autonomously moving the own vehicle by the vehicle moving speed increasing/decreasing control or the inter-vehicle distance increasing/decreasing control at the second driving mode in a situation where (i) the electronic control unit is executing the vehicle moving speed increasing/decreasing control or the inter-vehicle distance increasing/decreasing control while selectively executing the power control at the first state and the power control at the second state, and (ii) the control range change condition is unsatisfied.

When the own vehicle is moved by the autonomous moving control, i.e., the own vehicle is autonomously moved by the vehicle moving speed increasing/decreasing control or the inter-vehicle distance increasing/decreasing control at the first driving mode while selectively executing the power control at the first state and the power control at the second state, the broad vehicle moving speed range or the broad set inter-vehicle distance range may generally decrease an effect of reducing the consumed energy amount. However, when the own vehicle is autonomously moved by the vehicle moving speed increasing/decreasing control or the inter-vehicle distance increasing/decreasing control at the second driving mode, the broad set vehicle moving speed range or the broad inter-vehicle distance range does not much decrease the effect of reducing the consumed energy amount, but may increase a likelihood of disrupting the smooth traffic of the vehicles around the own vehicle.

With the vehicle driving assistance apparatus, the set vehicle moving speed range or the set inter-vehicle distance range set when the driving mode is the first driving mode, is broader than the set vehicle moving speed range or the set inter-vehicle distance range set when the driving mode is the second driving mode in a situation where (i) the own vehicle is autonomously moved by the vehicle moving speed increasing/decreasing control or the inter-vehicle distance increasing/decreasing control while selectively executing the power control at the first state and the power control at the second state, and (ii) the control range change condition is unsatisfied. Therefore, the smooth traffic of the vehicles around the own vehicle can be maintained, and a certain level of the effect of reducing the consumed energy amount can be realized.

A vehicle driving assistance method according to the present invention is a method of executing at least one of a vehicle moving speed increasing/decreasing control and an inter-vehicle distance increasing/decreasing control. The vehicle moving speed control corresponds to a control of autonomously moving an own vehicle while alternately increasing and decreasing a vehicle moving speed of the own vehicle within a set vehicle moving speed range. The inter-vehicle distance increasing/decreasing control corresponds to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range. In addition, the vehicle driving assistance method comprises a step of, while executing the vehicle moving speed increasing/decreasing control, setting the set vehicle moving speed range such that the set vehicle moving speed range set when a control range change condition is satisfied, is narrower than the set vehicle moving speed range set when the control range change condition is unsatisfied. The control range change condition corresponds to a condition that a following vehicle detection device which detects a following vehicle, is malfunctioning. In addition, the vehicle driving assistance method comprises a step of, while executing the inter-vehicle distance increasing/decreasing control, setting the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.

With the vehicle driving assistance method according to the present invention, for the reasons described above, the own vehicle can be autonomously moved by the autonomous moving control (i.e., the vehicle moving speed increasing/decreasing control or the inter-vehicle distance increasing/decreasing control) without disrupting the smooth traffic of the vehicles around the own vehicle when the following vehicle cannot be detected.

A computer-readable storage medium according to the present invention stores a vehicle driving assistance program configured to execute at least one of a vehicle moving speed increasing/decreasing control and an inter-vehicle distance increasing/decreasing control. The vehicle moving speed control corresponds to a control of autonomously moving an own vehicle while alternately increasing and decreasing a vehicle moving speed of the own vehicle within a set vehicle moving speed range. The inter-vehicle distance increasing/decreasing control corresponds to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range. The vehicle driving assistance program is configured to, while executing the vehicle moving speed increasing/decreasing control, set the set vehicle moving speed range such that the set vehicle moving speed range set when a control range change condition is satisfied, is narrower than the set vehicle moving speed range set when the control range change condition is unsatisfied. The control range change condition corresponds to a condition that a following vehicle detection device which detects a following vehicle, is malfunctioning. In addition, the vehicle driving assistance program is configured to, while executing the inter-vehicle distance increasing/decreasing control, set the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.

With the vehicle driving assistance program according to the present invention, for the reasons described above, the own vehicle can be autonomously moved by the autonomous moving control (i.e., the vehicle moving speed increasing/decreasing control or the inter-vehicle distance increasing/decreasing control) without disrupting the smooth traffic of the vehicles around the own vehicle when the following vehicle cannot be detected.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle driving assistance apparatus according to an embodiment of the present invention.

FIG. 2A is a view which shows a scene where a preceding vehicle exists ahead of an own vehicle.

FIG. 2B is a view which shows a scene where the preceding vehicle does not exist ahead of the own vehicle.

FIG. 3A is a view which shows a scene where the preceding vehicle does not exist ahead of the own vehicle, and a following vehicle exists behind the own vehicle.

FIG. 3B is a view which shows a scene where the preceding vehicle exists ahead of the own vehicle, and the following vehicle exists behind the own vehicle.

FIG. 4 is a view which shows a flowchart of a routine executed by the vehicle driving assistance apparatus according to the embodiment of the present invention.

FIG. 5 is a view which shows a flowchart of a routine executed by the vehicle driving assistance apparatus according to the embodiment of the present invention.

FIG. 6 is a view which shows a flowchart of a routine executed by the vehicle driving assistance apparatus according to the embodiment of the present invention.

FIG. 7 is a view which shows a flowchart of a routine executed by the vehicle driving assistance apparatus according to the embodiment of the present invention.

FIG. 8 is a view which shows a time chart showing changes of a road gradient and an own vehicle moving speed when an execution of an economy autonomous moving control is terminated, and a normal vehicle moving speed control is executed.

FIG. 9 is a view which shows a time chart showing changes of the road gradient and the own vehicle moving speed when the normal vehicle moving speed control is executed after the execution of the economy autonomous moving control is terminated, and a coasting control is executed.

FIG. 10 is a view which shows a flowchart of a routine executed by the vehicle driving assistance apparatus according to the embodiment of the present invention.

FIG. 11 is a view which shows a flowchart of a routine executed by the vehicle driving assistance apparatus according to the embodiment of the present invention.

FIG. 12 is a view which shows a flowchart of a routine executed by the vehicle driving assistance apparatus according to the embodiment of the present invention.

FIG. 13 is a view which shows a flowchart of a routine executed by the vehicle driving assistance apparatus according to the embodiment of the present invention.

### DESCRIPTION OF THE EMBODIMENTS

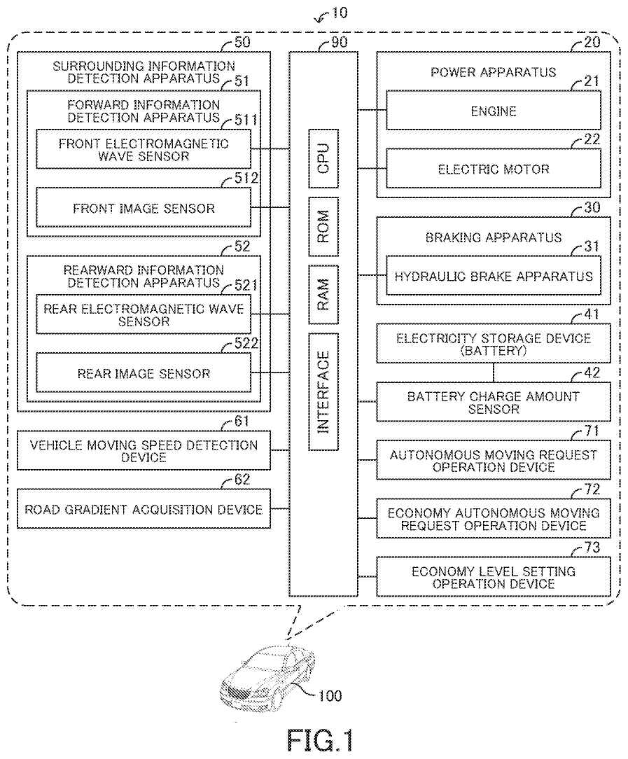

Below, a vehicle driving assistance apparatus, a vehicle driving assistance method, and a computer-readable storage medium storing a vehicle driving assistance program according to an embodiment of the present invention, will be described with reference to the drawings. The vehicle driving assistance apparatus 10 according to the embodiment of the present invention, is shown in FIG. 1. The vehicle driving assistance apparatus 10 is installed on an own vehicle 100. Hereinafter, the vehicle driving assistance apparatus 10 will be described with an example that an operator of the own vehicle 100 is a driver of the own vehicle 100, i.e., a person who is in the own vehicle 100 and directly drives the own vehicle 100.

In this regard, the operator of the own vehicle 100 may be a remote operator of the own vehicle 100, i.e., a person who is not in the own vehicle 100 and remotely drives the own vehicle 100. When the operator of the own vehicle 100 is the remote operator, the vehicle driving assistance apparatuses 10 are installed on the own vehicle 100 and a remote operation facility provided outside of the own vehicle 100 for remotely driving the own vehicle 100. In this case, functions of the vehicle driving assistance apparatus 10 described below are shared by the vehicle driving assistance apparatus 10 installed on the own vehicle 100 and the vehicle driving assistance apparatus 10 installed on the remote operation facility.

As shown in FIG. 1, the vehicle driving assistance apparatus 10 includes an ECU (i.e., an electronic control unit) 90 as a control unit. The ECU 90 includes a micro-computer as a main component. The micro-computer includes a CPU, a storage medium including a ROM, a RAM, and a non-volatile memory, and an interface. The CPU is configured or programmed to realize various functions by executing instructions, or programs, or routines stored in the storage medium. In particular, in the present embodiment, the vehicle driving assistance apparatus 10 memorizes programs to realize various controls executed by the vehicle driving assistance apparatus 10 in the storage medium.

It should be noted that the vehicle driving assistance apparatus 10 may be configured to update the programs stored in the storage medium with wireless communication (for example, internet communication) with external devices.

As shown in FIG. 1, a power apparatus 20 and a braking apparatus 30 are installed on the own vehicle 100. The power apparatus 20 is an apparatus which generates power to be applied to the own vehicle 100 (in particular, driven wheels of the own vehicle 100). In the present embodiment, the power apparatus 20 includes an internal combustion engine 21 and at least one electric motor 22. Further, the braking apparatus 30 is an apparatus which applies braking force to the own vehicle 100 (in particular, wheels of the own vehicle 100). In the present embodiment, the braking apparatus 30 includes a hydraulic brake apparatus 31. The internal combustion engine 21, the electric motor 22, and the hydraulic brake apparatus 31 are electrically connected to the ECU 90. The vehicle driving assistance apparatus 10 controls activations of the internal combustion engine 21, the electric motor 22, and the hydraulic brake apparatus 31.

Further, an electricity charge device 41 such as a battery and a battery charge amount sensor 42 are installed on the own vehicle 100. The electric motor 22 is activated by electricity stored in the electricity charge device 41. Further, the electric motor 22 generates electricity by the power output from the internal combustion engine 21 and stores the generated electricity in the electricity charge device 41. The battery charge amount sensor 42 is a sensor which detects an amount of electricity stored in the electricity charge device 41. The battery charge amount sensor 42 is electrically connected to the ECU 90. The vehicle driving assistance apparatus 10 detects an amount of electricity stored in the electricity charge device 41 by the battery charge amount sensor 42.

Further, a surrounding information detection apparatus 50 is installed on the own vehicle 100. The surrounding information detection apparatus 50 is an apparatus which acquires information on a situation around the own vehicle 100 as surrounding detection information IS. In the present embodiment, the surrounding information detection apparatus 50 includes a forward information detection device 51 and a rearward information detection device 52.

The forward information detection device 51 includes at least one front electromagnetic wave sensor 511 such as a radar sensor and at least one front image sensor 512 such as a camera sensor. The front electromagnetic wave sensor 511 and the front image sensor 512 are electrically connected to the ECU 90. The vehicle driving assistance apparatus 10 acquires forward object information IF_O (i.e., data on objects ahead of the own vehicle 100) by the front electromagnetic wave sensor 511 as forward detection information IF. Further, the vehicle driving assistance apparatus 10 acquires forward image information IF_C (i.e., data on an image of a view ahead of the own vehicle 100) by the front image sensor 512 as the forward detection information IF.

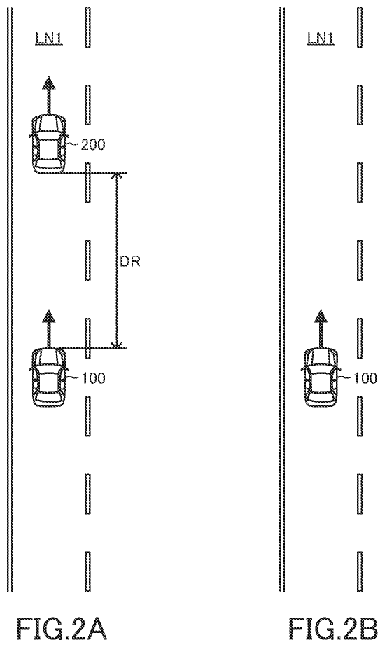

The vehicle driving assistance apparatus 10 detects a preceding vehicle 200 and a preceding vehicle distance DF based on the forward object information IF_O and/or the forward image information IF_C. As shown in FIG. 2A, the preceding vehicle 200 is a vehicle which is moving in an own vehicle moving lane LN1 ahead of the own vehicle 100 within a predetermined distance from the own vehicle 100. Further, the preceding vehicle distance DF corresponds to an inter-vehicle distance (i.e., a distance between the own vehicle 100 and the preceding vehicle 200).

Further, the rearward information detection device 52 includes at least one rear electromagnetic wave sensor 521 such as a radar sensor and at least one rear image sensor 522 such as a camera sensor. The rear electromagnetic wave sensor 521 and the rear image sensor 522 are electrically connected to the ECU 90. The vehicle driving assistance apparatus 10 acquires rearward object information IR_O (i.e., data on objects behind the own vehicle 100) by the rear electromagnetic wave sensor 521 as rearward detection information IR. Further, the vehicle driving assistance apparatus 10 acquires rearward image information IR_C (i.e., data on an image of a view behind the own vehicle 100) by the rear image sensor 522 as the rearward detection information IR.

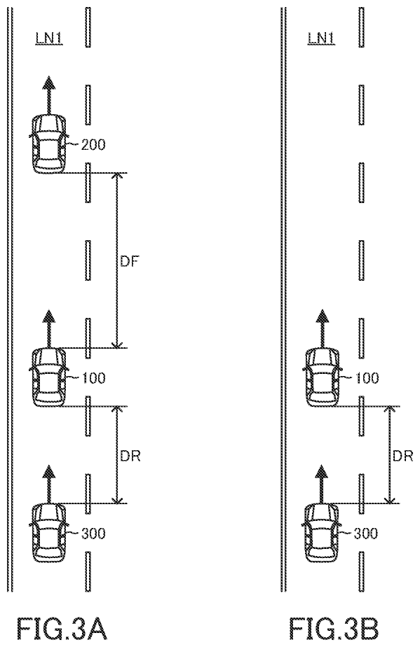

The vehicle driving assistance apparatus 10 detects a following vehicle 300 and a following vehicle distance DR based on the rearward object information IR_O and/or the rearward image information IR_C. As shown in FIG. 3A and FIG. 3B, the following vehicle 300 is a vehicle which is moving in the own vehicle moving lane LN1 behind the own vehicle 100 within a predetermined distance from the own vehicle 100. Further, the following vehicle distance DR corresponds to an inter-vehicle distance, i.e., a distance between the own vehicle 100 and the following vehicle 300.

### <Summary of Operations of Vehicle Driving Assistance Apparatus>

Next, a summary of operations of the vehicle driving assistance apparatus 10 will be described.

The vehicle driving assistance apparatus 10 is configured to execute an autonomous moving control of autonomously moving the own vehicle 100 at a first moving mode (for example, an economy vehicle moving speed control or an economy inter-vehicle distance control described later in detail). The autonomous moving control at the first moving mode corresponds to a control of selectively executing a power control at a first state (for example, a coasting control described later in detail) and a power control at a second state (for example, an optimum power running control described later in detail) while allowing a control value of the own vehicle 100 (for example, an own vehicle moving speed V, or the preceding vehicle distance DF, or a preceding vehicle reaching period of time TF described later in detail) to alternately increase and decrease within a set control range (for example, a set vehicle moving speed range R_V, or a set preceding inter-vehicle distance range R_DF, or a set preceding vehicle period-of-time range R_TF described later in detail). The first state corresponds to a state where a power generation loss of the power apparatus 20 or a power transmission loss from the power apparatus 20 to the driven wheels is reduced. The second state corresponds to a state where the power apparatus 20 is mechanically or electrically connected to the driven wheels to apply the power to the driven wheels.

In the present embodiment, applying the power to the driven wheels by mechanically connecting the power apparatus 20 to the driven wheels corresponds to inputting the power output from the internal combustion engine 21 to the driven wheels of the own vehicle 100. The own vehicle 100 is moved by inputting the power from the internal combustion engine 21 to the driven wheels. Further, in the present embodiment, inputting the power to the driven wheels by electrically connecting the power apparatus 20 corresponds to inputting the power output from the electric motor 22 to the driven wheels of the own vehicle 100. The own vehicle 100 is moved by inputting the power from the electric motor 22 to the driven wheels.

Also, the vehicle driving assistance apparatus 10 is configured to execute the autonomous moving control at a second moving mode (for example, a normal vehicle moving speed control or a normal inter-vehicle distance control described later in detail). The autonomous moving control at the second moving mode corresponds to a control of maintaining the control value of the own vehicle 100 (for example, the own vehicle moving speed V, or the preceding vehicle distance DF, or the preceding vehicle reaching period of time TF described later in detail) at a set control value (for example, a set vehicle moving speed V_S, or a set preceding vehicle distance DF_S, or a set preceding vehicle reaching period of time TF_S described later in detail).

Further, the vehicle driving assistance apparatus 10 is configured to select any of a first driving mode and a second driving mode as a driving mode of driving the own vehicle 100 and execute any of the autonomous moving control at the first driving mode and the autonomous moving control at the second driving mode. The first driving mode corresponds to a mode capable of using the power other than the power generated by the electricity from the electricity charge device to move the own vehicle 100. For example, the first driving mode corresponds to a hybrid driving mode described later in detail. The second driving mode corresponds to a mode of using the power generated by the electricity from the electricity charge device only to move the own vehicle 100. For example, the second driving mode corresponds to a motor driving mode described later in detail.

In other words, the vehicle driving assistance apparatus 10 is configured to selectively execute a vehicle moving speed increasing/decreasing control and an inter-vehicle distance increasing/decreasing control. The vehicle moving speed increasing/decreasing control corresponds to a control of autonomously moving the own vehicle 100 while alternately increasing and decreasing a vehicle moving speed of the own vehicle 100 within the set vehicle moving speed range. For example, the vehicle moving speed increasing/decreasing control corresponds to the economy vehicle moving speed control described later in detail. The inter-vehicle distance increasing/decreasing control corresponds to a control of autonomously moving the own vehicle 100 while alternately increasing and decreasing the inter-vehicle distance within a set inter-vehicle distance range. The inter-vehicle distance corresponds to a distance between the own vehicle 100 and another vehicle around the own vehicle 100 (for example, a preceding vehicle 200). Alternatively, the inter-vehicle distance increasing/decreasing control corresponds to a control of autonomously moving the own vehicle 100 while alternately increasing and decreasing a period of time required for the own vehicle 100 to move the inter-vehicle distance within a set period-of-time range. For example, the inter-vehicle distance increasing/decreasing control corresponds to the economy inter-vehicle distance control described later in detail.

In addition, the vehicle driving assistance apparatus 10 is configured to selectively execute a vehicle moving speed maintaining control and an inter-vehicle distance maintaining control. The vehicle moving speed maintaining control corresponds to a control of autonomously moving the own vehicle 100 while maintaining the vehicle moving speed of the own vehicle 100 at the set vehicle moving speed. For example, the vehicle moving speed maintaining control corresponds to the normal vehicle moving speed control described later in detail. The inter-vehicle distance maintaining control corresponds to a control of autonomously moving the own vehicle 100 while maintaining the inter-vehicle distance between the own vehicle 100 and the other vehicle around the own vehicle 100 (for example, the preceding vehicle 200) at a set inter-vehicle distance. Alternatively, the inter-vehicle distance maintaining control corresponds to a control of maintaining the period of time required for the own vehicle 100 to move the inter-vehicle distance at a set period of time. For example, the inter-vehicle distance maintaining control corresponds to the normal inter-vehicle distance control described later in detail.

Further, the vehicle driving assistance apparatus 10 is configured to execute the vehicle moving speed increasing/decreasing control and the inter-vehicle distance increasing/decreasing control (for example, the economy vehicle moving speed control and the economy inter-vehicle distance control described later in detail) at any one of the first driving mode and the second driving mode. The first driving mode corresponds to a mode of moving the own vehicle 100 by activating both of the internal combustion engine 21 and the electric motor 22 or activating the internal combustion engine 21 only to apply the power to the own vehicle 100. For example, the first driving mode corresponds to the hybrid driving mode described later in detail. The second mode corresponds to a mode of moving the own vehicle 100 by activating the electric motor 22 only to apply the power to the own vehicle 100. For example, the second driving mode corresponds to the motor driving mode described later in detail.

Further, the vehicle driving assistance apparatus 10 is configured to execute the vehicle moving speed increasing/decreasing control and the inter-vehicle distance increasing/decreasing control (for example, the economy vehicle moving speed control and the economy inter-vehicle distance control described later in detail) by selectively executing the power control at the first state and the power control at the second state. The first state corresponds to a state in which the power generation loss in the power apparatus 20 of the own vehicle 100 or the power transmission loss from the power apparatus 20 to the driven wheels of the own vehicle 100, is reduced. For example, the power control at the first state corresponds to the coasting control described later in detail. The second state corresponds to a state in which the power apparatus 20 is mechanically or electrically connected to the driven wheels and the power is applied to the driven wheels. For example, the power control at the second state corresponds to the optimum power running control described later in detail.

It should be noted that in the present embodiment, the vehicle driving assistance apparatus 10 realizes the first state in which the power generation loss in the power apparatus 20 is reduced by stopping activating the internal combustion engine 21 to reduce an engine consumed energy amount or stopping supplying the electricity from the electricity charge device 41 to the electric motor 22 to reduce a motor consumed energy amount. The engine consumed energy amount corresponds to an amount of energy consumed by the internal combustion engine 21 to generate the power. The motor consumed energy amount corresponds to an amount of energy consumed to generate the power by the electric motor 22.

Further, in the present embodiment, the vehicle driving assistance apparatus 10 realizes the first state in which the power transmission loss from the power apparatus 20 to the driven wheels of the own vehicle 100 is reduced by disconnecting a power transmission system from the power apparatus 20 to the driven wheels of the own vehicle 100 (in particular, by putting a so-called clutch in a disconnected state).

Furthermore, in the present embodiment, the vehicle driving assistance apparatus 10 realizes the second state in which the power apparatus 20 is mechanically connected to the driven wheels of the own vehicle 100 to apply the power to the driven wheels by establishing the power transmission system from the power apparatus 20 to the driven wheels of the own vehicle 100 and applying the power from the internal combustion engine 21 to the driven wheels of the own vehicle 100 through the power transmission system. In particular, the vehicle driving assistance apparatus 10 is configured to realize the second state in which the power apparatus 20 is mechanically connected to the driven wheels of the own vehicle 100 to apply the power to the driven wheels by executing the optimum power running control described later in detail.

Further, in the present embodiment, the vehicle driving assistance apparatus 10 is configured to realize the second state in which the power apparatus 20 is electrically connected to the driven wheels of the own vehicle 100 to apply the power to the driven wheels by establishing the power transmission system from the power apparatus 20 to the driven wheels of the own vehicle 100 and applying the power from the electric motor 22 to the driven wheels of the own vehicle 100 through the power transmission system.

Next, controls executed by the vehicle driving assistance apparatus 10 will be described in detail with an example that the other vehicle around the own vehicle 100 is the preceding vehicle 200.

The vehicle driving assistance apparatus 10 executes the autonomous moving control as an automatic driving control or an autonomous driving control. The autonomous moving control corresponds to a control of moving the own vehicle 100 by autonomously controlling activations of the power apparatus 20 and the braking apparatus 30 to accelerate or decelerate the own vehicle 100. In the present embodiment, the autonomous moving control includes an inter-vehicle distance control and a vehicle moving speed control.

The inter-vehicle distance control is executed to autonomously accelerate or decelerate the own vehicle 100 with respect to the set preceding vehicle distance DF_S when the preceding vehicle 200 exists ahead of the own vehicle 100 as shown in FIG. 2A. The set preceding vehicle distance DF_S corresponds to the preceding vehicle distance DF which is set by the driver as a control target used in the inter-vehicle distance control.

Alternatively, the inter-vehicle distance control may be executed to autonomously accelerate or decelerate the own vehicle 100 with respect to the set preceding vehicle reaching period of time TF_S when the preceding vehicle 200 exists ahead of the own vehicle 100. The set preceding vehicle reaching period of time TF_S corresponds to the preceding vehicle reaching period of time TF which is set by the driver as a control target used in the inter-vehicle distance control. The preceding vehicle reaching period of time TF corresponds to a value which is acquired by dividing the preceding vehicle distance DF by the own vehicle moving speed V (T=DF/V). Therefore, the preceding vehicle reaching period of time TF corresponds to the period of time which is required for the own vehicle 100 to move the preceding vehicle distance DF.

In particular, the inter-vehicle distance control includes the normal inter-vehicle distance control and the economy inter-vehicle distance control.

The normal inter-vehicle distance control is one of normal autonomous moving controls. In particular, the normal inter-vehicle distance control corresponds to a control of autonomously moving the own vehicle 100 while maintaining the preceding vehicle distance DF at the set preceding vehicle distance DF_S. Alternatively, the normal inter-vehicle distance control may correspond to a control of autonomously moving the own vehicle 100 while maintaining the preceding vehicle reaching period of time TF at the set preceding vehicle reaching period of time TF_S. Therefore, the normal inter-vehicle distance control is a so-called following moving control or a so-called adaptive cruise control.

It should be noted that the vehicle driving assistance apparatus 10 may be configured to execute the normal vehicle moving speed control described later in detail (or a constant speed control) when the own vehicle moving speed V increases and reaches the set vehicle moving speed V_S while the vehicle driving assistance apparatus 10 is executing the normal inter-vehicle distance control.

The economy inter-vehicle distance control is one of economy autonomous moving controls. The economy inter-vehicle distance control corresponds to a control of autonomously moving the own vehicle 100 while alternately increasing and decreasing the preceding vehicle distance DF within a predetermined range or the set preceding vehicle distance range R_DF by starting to execute the coasting control when the preceding vehicle distance DF decreases and reaches a lower limit preceding vehicle distance DF_L (i.e., a lower limit value of the set preceding vehicle distance range R_DF) and starting to execute the optimum power running control when the preceding vehicle distance DF increases and reaches an upper limit preceding vehicle distance DF_U (i.e., an upper limit value of the set preceding vehicle distance range R_DF). The coasting control corresponds to a control of causing the own vehicle 100 to coast. The optimum power running control corresponds to a control of moving the own vehicle 100 with the power. In other words, the economy inter-vehicle distance control corresponds to a control of alternately performing a power running of the own vehicle 100 and a coasting of the own vehicle 100, allowing the preceding vehicle distance DF to change within the predetermined range or the set preceding vehicle distance range R_DF.

Alternatively, the economy inter-vehicle distance control corresponds to a control of autonomously moving the own vehicle 100 while alternately increasing and decreasing the preceding vehicle reaching period of time TF within a predetermined range or the set preceding vehicle period-of-time range R_TF by starting to execute the coasting control of causing the own vehicle 100 to coast when the preceding vehicle reaching period of time TF decreases and reaches a lower limit preceding vehicle period of time TF_L (i.e., a lower limit value of the set preceding vehicle period-of-time range R_TF) and starting to execute the optimum power running control of moving the own vehicle 100 with the power when the preceding vehicle reaching period of time TF increases and reaches an upper limit preceding vehicle period of time TF_U (i.e., an upper limit value of the set preceding vehicle period-of-time range R_TF). In other words, the economy inter-vehicle distance control corresponds to a control of alternately performing the power running of the own vehicle 100 and the coasting of the own vehicle 100, allowing the preceding vehicle reaching period of time TF to change within the predetermined range or the set preceding vehicle period-of-time range R_TF.

It should be noted that in the present embodiment, the set preceding vehicle distance range R_DF corresponds to a range which includes the set preceding vehicle distance DF_S. In particular, the set preceding vehicle distance range R_DF corresponds to a range which has the upper limit preceding vehicle distance DF_U and the lower limit preceding vehicle distance DF_L. The upper limit preceding vehicle distance DF_U corresponds to the inter-vehicle distance greater than the set preceding vehicle distance DF_S by a predetermined value or a control inter-vehicle distance width dD (DF_U=DF_S+dD). The lower limit preceding vehicle distance DF_L corresponds to the inter-vehicle distance smaller than the set preceding vehicle distance DF_S by the predetermined value or the control inter-vehicle distance width dD (DF_L=DF_S−dD).

Further, in the present embodiment, the set preceding vehicle period-of-time range R_TF corresponds to a range which includes the set preceding vehicle reaching period of time TF_S. In particular, the set preceding vehicle period-of-time range R_TF corresponds to a range which has the upper limit preceding vehicle period of time TF_U and the lower limit preceding vehicle period of time TF_L. The upper limit preceding vehicle period of time TF_U corresponds to a period of time greater than the set preceding vehicle reaching period of time TF_S by a predetermined value or a control inter-vehicle period-of-time width dT (TF_U=TF_S+dT). The lower limit preceding vehicle period of time TF_L corresponds to a period of time smaller than the set preceding vehicle reaching period of time TF_S by the predetermined value or the control inter-vehicle period-of-time width dT as (TF_L=TF_S−dT).

Further, the optimum power running control corresponds to a control of controlling the activation of the power apparatus 20 so as to output the power from the power apparatus 20 at a maximum energy efficiency or an energy efficiency near the maximum energy efficiency. In particular, the optimum power running control corresponds to a control of activating the internal combustion engine 21 at an optimum activation point or an activation point near the optimum activation point. Furthermore, the coasting control corresponds to a control of controlling the activation of the power apparatus 20 so as to cause the own vehicle 100 to coast.

On the other hand, the vehicle moving speed control is executed to autonomously control the own vehicle moving speed V (i.e., the vehicle moving speed of the own vehicle 100) with respect to the set vehicle moving speed V_S when the preceding vehicle 200 does not exist ahead of the own vehicle 100 as shown in FIG. 2B. The set vehicle moving speed V_S corresponds to the own vehicle moving speed V (i.e., the vehicle moving speed of the own vehicle 100) which is set by the driver as a control target used in the vehicle moving speed control.

As shown in FIG. 1, a vehicle moving speed detection device 61 is installed on the own vehicle 100. The vehicle moving speed detection device 61 may include vehicle wheel rotation speed sensors. The vehicle moving speed detection device 61 is electrically connected to the ECU 90. The vehicle driving assistance apparatus 10 acquires the own vehicle moving speed V by the vehicle moving speed detection device 61.

In particular, the vehicle moving speed control includes the normal vehicle moving speed control and the economy vehicle moving speed control.

The normal vehicle moving speed control is one of the normal autonomous moving controls. In particular, the normal vehicle moving speed control corresponds to a control of autonomously moving the own vehicle 100 while maintaining the own vehicle moving speed V at the set vehicle moving speed V_S. Therefore, the normal vehicle moving speed control is the so-called constant speed control or a so-called cruise control.

The economy vehicle moving speed control corresponds to a control of autonomously moving the own vehicle 100 while alternately increasing and decreasing the own vehicle moving speed V within a predetermined range or the set vehicle moving speed range R_V by starting to execute the coasting control when the own vehicle moving speed V increases and reaches an upper limit vehicle moving speed V_U (i.e., an upper limit value of the set vehicle moving speed range R_V) and starting to execute the optimum power running control when the own vehicle moving speed V decreases and reaches a lower limit vehicle moving speed V_L (i.e., a lower limit value of the set vehicle moving speed range R_V). In other words, the economy vehicle moving speed control corresponds to a control of alternately performing the power running of the own vehicle 100 and the coasting of the own vehicle 100, allowing the own vehicle moving speed V to change within the predetermined range or the set vehicle moving speed range R_V.

It should be noted that in the present embodiment, the set vehicle moving speed range R_V corresponds to a range which includes the set vehicle moving speed V_S. In particular, the set vehicle moving speed range R_V corresponds to a range which has the upper limit vehicle moving speed V_U and the lower limit vehicle moving speed V_L. The upper limit vehicle moving speed V_U corresponds to the vehicle moving speed greater than the set vehicle moving speed V_S by a predetermined value or a control vehicle moving speed width dV (V_U=V_S+dV). The lower limit vehicle moving speed V_L corresponds to the vehicle moving speed smaller than the set vehicle moving speed V_S by the predetermined value or the control vehicle moving speed width dV (V_L=V_S−dV).

### <Specific Operations of Vehicle Driving Assistance Apparatus>

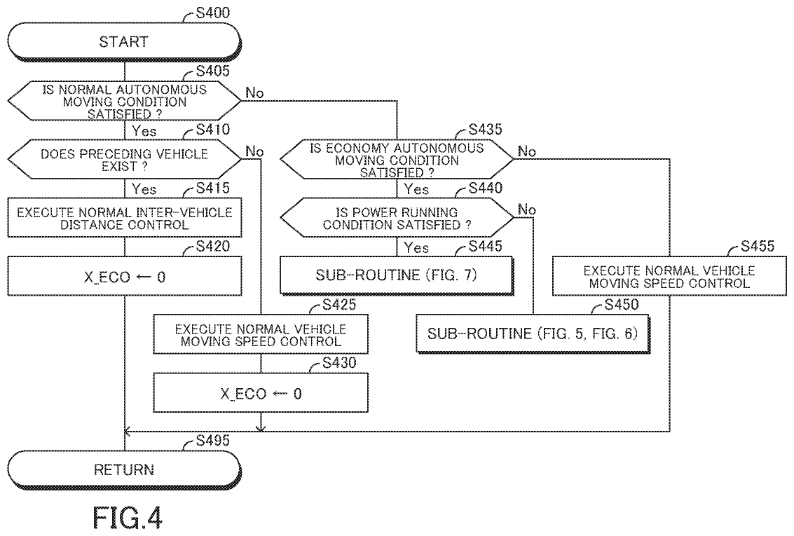

Next, specific operations of the vehicle driving assistance apparatus 10 will be described. The vehicle driving assistance apparatus 10 executes the autonomous moving control by executing a routine shown in FIG. 4 with a predetermined calculation cycle.

At a predetermined point of time, the vehicle driving assistance apparatus 10 starts a process from a step S400 of the routine shown in FIG. 4 and proceeds with the process to a step S405 to determine whether a normal autonomous moving condition C1 is satisfied.

The normal autonomous moving condition C1 corresponds to a condition that (i) an autonomous moving permission condition C2 is satisfied, (ii) an execution of the autonomous moving control is requested, and (iii) an execution of the economy autonomous moving control (or an economy moving control) is not requested. It should be noted that the economy autonomous moving control includes the economy vehicle moving speed control and the economy inter-vehicle distance control. Further, the economy autonomous moving control corresponds to a control of moving the own vehicle 100 in a pulse-and-glide fashion.

Furthermore, the autonomous moving permission condition C2 corresponds to (i) a condition that systems required for executing the autonomous moving control function normally, for example, the surrounding information detection apparatus 50 functions normally, or (ii) a condition that a gradient of a road on which the own vehicle 100 is moving, is not relatively great, and thus the execution of the economy autonomous moving control is permitted. It should be noted that the normal autonomous moving condition C1 may not include a condition that the autonomous moving permission condition C2 is satisfied.

Further, as shown in FIG. 1, an autonomous moving request operation device 71 such as a moving assistance button and an economy autonomous moving request operation device 72 such as an economy moving button are provided on the own vehicle 100. The autonomous moving request operation device 71 and the economy autonomous moving request operation device 72 are electrically connected to the ECU 90. The driver can request the vehicle driving assistance apparatus 10 to execute the autonomous moving control by operating the autonomous moving request operation device 71. Further, the driver can request the vehicle driving assistance apparatus 10 to execute the economy autonomous moving control by operating the economy autonomous moving request operation device 72.

When the vehicle driving assistance apparatus 10 determines “Yes” at the step S405, the vehicle driving assistance apparatus 10 proceeds with the process to a step S410 to determine whether the preceding vehicle 200 exists.

When the vehicle driving assistance apparatus 10 determines “Yes” at the step S410, the vehicle driving assistance apparatus 10 proceeds with the process to a step S415 to execute the normal inter-vehicle distance control as the autonomous moving control. Next, the vehicle driving assistance apparatus 10 proceeds with the process to a step S420 to set a value of an economy autonomous moving flag X_ECO to “0”. Then, the vehicle driving assistance apparatus 10 proceeds with the process to a step S495 to terminate executing this routine once.

On the other hand, when the vehicle driving assistance apparatus 10 determines “No” at the step S410, the vehicle driving assistance apparatus 10 proceeds with the process to a step S425 to execute the normal vehicle moving speed control as the autonomous moving control. Next, the vehicle driving assistance apparatus 10 proceeds with the process to a step S430 to set the value of the economy autonomous moving flag X_ECO to “0”. Then, the vehicle driving assistance apparatus 10 proceeds with the process to the step S495 to terminate executing this routine once.

Further, when the vehicle driving assistance apparatus 10 determines “No” at the step 405, the vehicle driving assistance apparatus 10 proceeds with the process to a step S435 to determine whether an economy autonomous moving condition C3 is satisfied.

The economy autonomous moving condition C3 corresponds to a condition that (i) the autonomous moving permission condition C2 is satisfied, (ii) the execution of the autonomous moving control is requested, and (iii) the execution of the economy autonomous moving control is requested. It should be noted that the economy autonomous moving condition C3 may not include the condition that the autonomous moving permission condition C2 is satisfied.

When the vehicle driving assistance apparatus 10 determines “Yes” at the step S435, the vehicle driving assistance apparatus 10 proceeds with the process to a step S440 to determine whether a power running condition C4 described later in detail is satisfied.

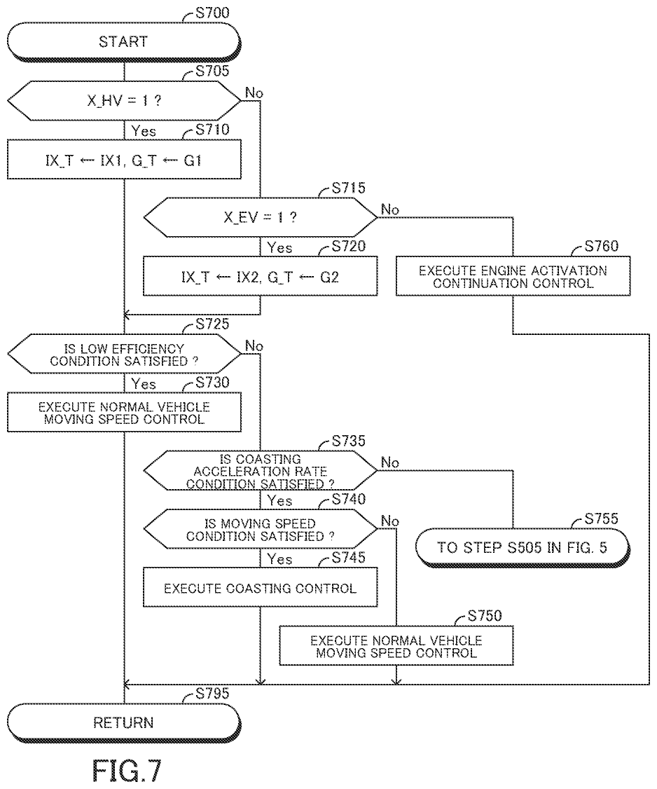

When the vehicle driving assistance apparatus 10 determines “Yes” at the step S440, the vehicle driving assistance apparatus 10 proceeds with the process to a step S445 to execute a routine shown in FIG. 7. This routine will be described later in detail.

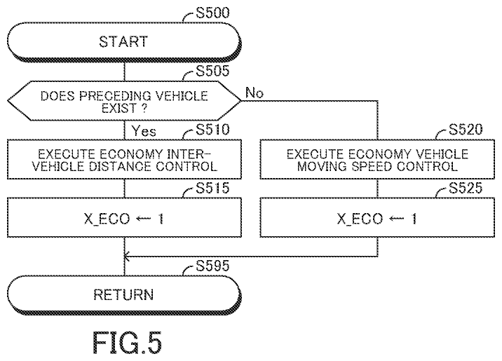

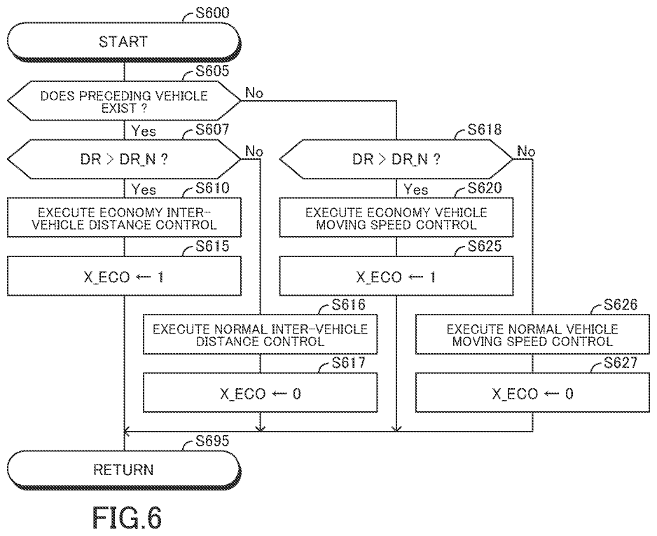

On the other hand, when the vehicle driving assistance apparatus 10 determines “No” at the step S440, the vehicle driving assistance apparatus 10 proceeds with the process to a step S450 to execute a routine shown in FIG. 5 or FIG. 6.

Therefore, when the vehicle driving assistance apparatus 10 is configured to execute the routine shown in FIG. 5 when the vehicle driving assistance apparatus 10 proceeds with the process to the step S450, the vehicle driving assistance apparatus 10 starts a process from a step S500 of the routine shown in FIG. 5 and proceeds with the process to a step S505 to determine whether the preceding vehicle 200 exists.

When the vehicle driving assistance apparatus 10 determines “Yes” at the step S505, the vehicle driving assistance apparatus 10 proceeds with the process to a step S510 to execute the economy inter-vehicle distance control as the autonomous moving control. Next, the vehicle driving assistance apparatus 10 proceeds with the process to a step S515 to set the value of the economy autonomous moving flag X_ECO to “1”. Then, the vehicle driving assistance apparatus 10 proceeds with the process to a step S595 to terminate executing this routine once.

On the other hand, when the vehicle driving assistance apparatus 10 determines “No” at the step S505, the vehicle driving assistance apparatus 10 proceeds with the process to a step S520 to execute the economy vehicle moving speed control as the autonomous moving control. Next, the vehicle driving assistance apparatus 10 proceeds with the process to a step S525 to set the value of the economy autonomous moving flag X_ECO to “1”. Then, the vehicle driving assistance apparatus 10 proceeds with the process to the step S595 to terminate executing this routine once.

Alternatively, when the vehicle driving assistance apparatus 10 is configured to execute the routine shown in FIG. 6 when the vehicle driving assistance apparatus 10 proceeds with the process to the step S450, the vehicle driving assistance apparatus 10 starts a process from a step S600 of the routine shown in FIG. 6 and proceeds with the process to a step S605 to determine whether the preceding vehicle 200 exists.

When the vehicle driving assistance apparatus 10 determines “Yes” at the step S605, the vehicle driving assistance apparatus 10 proceeds with the process to a step S607 to determine whether the following vehicle distance DR is greater than a predetermined distance or a proximity determination distance DR_N.

It should be noted that the vehicle driving assistance apparatus 10 may be configured to determine whether a following vehicle reaching period of time TR is greater than a predetermined period of time or a proximity determination period of time TR_N. The following vehicle reaching period of time TR corresponds to a value which is acquired by dividing the following vehicle distance DR by the following vehicle moving speed VR, i.e., a vehicle moving speed of the following vehicle 300 (TR=DR/VR). Therefore, the following vehicle reaching period of time TR is a period of time which is required for the following vehicle 300 to move the following vehicle distance DR.

When the vehicle driving assistance apparatus 10 determines “Yes” at the step S607, the vehicle driving assistance apparatus 10 proceeds with the process to a step S610 to execute the economy inter-vehicle distance control as the autonomous moving control. Next, the vehicle driving assistance apparatus 10 proceeds with the process to a step S615 to set the value of the economy autonomous moving flag X_ECO to “1”. Then, the vehicle driving assistance apparatus 10 proceeds with the process to a step S695 to terminate executing this routine once.

On the other hand, when the vehicle driving assistance apparatus 10 determines “No” at the step S607, the vehicle driving assistance apparatus 10 proceeds with the process to a step S616 to stop executing the economy inter-vehicle distance control and execute the normal inter-vehicle distance control. Next, the vehicle driving assistance apparatus 10 proceeds with the process to a step S617 to set the value of the economy autonomous moving flag X_ECO to “0”. Then, the vehicle driving assistance apparatus 10 proceeds with the process to the step S695 to terminate executing this routine once.

As described above, the vehicle driving assistance apparatus 10 is configured to execute the normal inter-vehicle distance control of maintaining the preceding vehicle distance DF at the set preceding vehicle distance DF_S (i.e., the autonomous moving control at the second moving mode of maintaining the control value at the set control value). Further, the vehicle driving assistance apparatus 10 is configured to change a control of autonomously moving the own vehicle 100 from the economy inter-vehicle distance control to the normal inter-vehicle distance control (i.e., change a mode of autonomously moving the own vehicle 100 from the first moving mode to the second moving mode) when the condition that (i) the following vehicle distance DR is equal to or smaller than the proximity determination distance DR_N, or (ii) the following vehicle reaching period of time TR is equal to or smaller than the proximity determination period of time TR_N becomes satisfied (i.e. when a moving mode change condition becomes satisfied) while the vehicle driving assistance apparatus 10 is executing the economy inter-vehicle distance control (i.e., the autonomous moving control at the first moving mode). The moving mode change condition corresponds to a condition that (i) a following vehicle detection device which detects the following vehicle 300 normally functions, (ii) the following vehicle 300 is detected, and (iii) the distance between the following vehicle 300 and the own vehicle 100 is equal to or smaller than the predetermined distance, or the period of time required for the following vehicle 300 to move the distance between the following vehicle 300 and the own vehicle 100, is equal to or smaller than the predetermined period of time.

When the preceding vehicle distance DF alternately and excessively increases or decreases in a situation where the own vehicle 100 is autonomously moved by the economy inter-vehicle distance control, and the following vehicle 300 exists, the vehicle moving speed of the following vehicle 300 alternately and considerably increases or decreases. As a result, it may disrupt smooth traffic of vehicles including the following vehicle 300 around the own vehicle 100.

With the vehicle driving assistance apparatus 10, when the following vehicle 300 exists relatively near the own vehicle 100, the control of autonomously moving the own vehicle 100 is changed from the economy inter-vehicle distance control to the normal inter-vehicle distance control. Thereby, the preceding vehicle distance DF is maintained at a constant distance. Therefore, even when the following vehicle 300 exists relatively near the own vehicle 100, the own vehicle 100 can be autonomously moved so as to maintain the smooth traffic of the vehicles around the own vehicle 100.

Further, the vehicle driving assistance apparatus 10 is configured to execute the normal inter-vehicle distance control (i.e., the inter-vehicle distance maintaining control) of autonomously moving the own vehicle 100 while maintaining the preceding vehicle distance DF (i.e., the inter-vehicle distance) at the set preceding vehicle distance DF_S (i.e., the set inter-vehicle distance), or maintaining the preceding vehicle reaching period of time TF (i.e., the period of time which is required for the own vehicle 100 to move the inter-vehicle distance between the own vehicle 100 and the vehicle around the own vehicle 100) at the set preceding vehicle reaching period of time TF_S (i.e., the set period of time). Further, the vehicle driving assistance apparatus 10 is configured to stop executing the economy inter-vehicle distance control (i.e., the inter-vehicle distance increasing/decreasing control) and execute the normal inter-vehicle distance control (i.e., the inter-vehicle distance maintaining control) when a condition that (i) the following vehicle distance DR is equal to or smaller than the proximity determination distance DR_N, or (ii) the following vehicle reaching period of time TR is equal to or smaller than the proximity determination period of time TR_N becomes satisfied (i.e., the moving mode change condition becomes satisfied) while the vehicle driving assistance apparatus 10 is executing the economy inter-vehicle distance control (i.e., the inter-vehicle distance increasing/decreasing control). The moving mode change condition corresponds to a condition that (i) the following vehicle detection apparatus which detects the following vehicle 300 normally functions, (ii) the following vehicle 300 is detected, and (iii) the distance between the following vehicle 300 and the own vehicle 100 is equal to or smaller than the predetermined distance, or the period of time required for the own vehicle 100 to move the distance between the following vehicle 300 and the own vehicle 100, is equal to or smaller than the predetermined period of time.

When the preceding vehicle distance DF alternately and excessively increases and decreases in a situation where the own vehicle 100 is autonomously moved by the economy inter-vehicle distance control, and the following vehicle 300 exists, the vehicle moving speed of the following vehicle 300 alternately and considerably increases and decreases. As a result, it may disrupt the smooth traffic of vehicles including the following vehicle 300 around the own vehicle 100.

With the vehicle driving assistance apparatus 10, when the following vehicle 300 exists relatively near the own vehicle 100, an execution of the economy inter-vehicle distance control is stopped, and the normal inter-vehicle distance control is executed. Thereby, the preceding vehicle distance DF is maintained at a constant distance. Therefore, even when the following vehicle 300 exists relatively near the own vehicle 100, the own vehicle 100 can be autonomously moved so as to maintain the smooth traffic of the vehicles around the own vehicle 100.

On the other hand, when the vehicle driving assistance apparatus 10 determines “No” at the step S605, the vehicle driving assistance apparatus 10 proceeds with the process to a step S618 to determine whether the following vehicle distance DR is greater than the proximity determination distance DR_N.

It should be noted that the vehicle driving assistance apparatus 10 may be configured to determine whether the following vehicle reaching period of time TR is greater than the proximity determination period of time TR_N.

When the vehicle driving assistance apparatus 10 determines “Yes” at the step S618, the vehicle driving assistance apparatus 10 proceeds with the process to a step S620 to execute the economy vehicle moving speed control as the autonomous moving control. Next, the vehicle driving assistance apparatus 10 proceeds with the process to a step S625 to set the value of the economy autonomous moving flag X_ECO to “1”. Then, the vehicle driving assistance apparatus 10 proceeds with the process to the step S695 to terminate executing this routine once.

On the other hand, when the vehicle driving assistance apparatus 10 determines “No” at the step S618, the vehicle driving assistance apparatus 10 proceeds with the process to a step S626 to stop executing the economy vehicle moving speed control and execute the normal vehicle moving speed control. Next, the vehicle driving assistance apparatus 10 proceeds with the process to a step S627 to set the value of the economy autonomous moving flag X_ECO to “0”. Then, the vehicle driving assistance apparatus 10 proceeds with the process to the step S695 to terminate executing this routine once.

As described above, the vehicle driving assistance apparatus 10 is configured to execute the normal vehicle moving speed control of maintaining the own vehicle moving speed V at the set vehicle moving speed V_S (i.e., the autonomous moving control at the second moving mode of maintaining the control value at the set control value). Further, the vehicle driving assistance apparatus 10 is configured to change the control of autonomously moving the own vehicle 100 from the economy vehicle moving speed control to the normal vehicle moving speed control (i.e., change the mode of autonomously moving the own vehicle 100 from the first moving mode to the second moving mode) when the condition that (i) the following vehicle distance DR is equal to or smaller than the proximity determination distance DR_N, or (ii) the following vehicle reaching period of time TR is equal to or smaller than the proximity determination period of time TR_N becomes satisfied (i.e. when the moving mode change condition becomes satisfied) while the vehicle driving assistance apparatus 10 is executing the economy vehicle moving speed control (i.e., the autonomous moving control at the first moving mode). The moving mode change condition corresponds to the condition that (i) the following vehicle detection apparatus which detects the following vehicle 300 normally functions, (ii) the following vehicle 300 is detected, and (iii) the distance between the following vehicle 300 and the own vehicle 100 is equal to or smaller than the predetermined distance, or the period of time required for the following vehicle 300 to move the distance between the following vehicle 300 and the own vehicle 100, is equal to or smaller than the predetermined period of time.

When the own vehicle moving speed V alternately and excessively increases and decreases in a situation where the own vehicle 100 is autonomously moved by the economy vehicle moving speed control, and the following vehicle 300 exists, the vehicle moving speed of the following vehicle 300 alternately and considerably increases and decreases. As a result, it may disrupt the smooth traffic of vehicles including the following vehicle 300 around the own vehicle 100.

With the vehicle driving assistance apparatus 10, when the following vehicle 300 exists relatively near the own vehicle 100, the control of autonomously moving the own vehicle 100 is changed from the economy vehicle moving speed control to the normal vehicle moving speed control. Thereby, the own vehicle moving speed V is maintained at a constant speed. Therefore, even when the following vehicle 300 exists relatively near the own vehicle 100, the own vehicle 100 can be autonomously moved so as to maintain the smooth traffic of the vehicles around the own vehicle 100.

Further, the vehicle driving assistance apparatus 10 is configured to execute the normal vehicle moving speed control (i.e., the vehicle moving speed maintaining control) while maintaining the own vehicle moving speed V at the set vehicle moving speed V_S. Further, the vehicle driving assistance apparatus 10 is configured to stop executing the economy vehicle moving speed control (i.e., the vehicle moving speed increasing/decreasing control) and execute the normal vehicle moving speed control (i.e., the vehicle moving speed maintaining control) when the condition that (i) the following vehicle distance DR is equal to or smaller than the proximity determination distance DR_N, or (ii) the following vehicle reaching period of time TR is equal to or smaller than the proximity determination period of time TR_N, becomes satisfied (i.e., the moving mode change condition becomes satisfied) while the vehicle driving assistance apparatus 10 is executing the economy vehicle moving speed control (i.e., the vehicle moving speed increasing/decreasing control). The moving mode change condition corresponds to the condition that (i) the following vehicle detection apparatus which detects the following vehicle 300 normally functions, (ii) the following vehicle 300 is detected, and (iii) the distance between the following vehicle 300 and the own vehicle 100 is equal to or smaller than the predetermined distance, or the period of time required for the own vehicle 100 to move the distance between the following vehicle 300 and the own vehicle 100, is equal to or smaller than the predetermined period of time.

When the own vehicle moving speed V alternately and excessively increases or decreases in a situation where the own vehicle 100 is autonomously moved by the economy vehicle moving speed control, and the following vehicle 300 exists, the vehicle moving speed of the following vehicle 300 alternately and considerably increases and decreases. As a result, it may disrupt the smooth traffic of vehicles including the following vehicle 300 around the own vehicle 100.

With the vehicle driving assistance apparatus 10, when the following vehicle 300 exists relatively near the own vehicle 100, an execution of the economy vehicle moving speed control is stopped, and the normal vehicle moving speed control is executed. Thereby, the own vehicle moving speed V is maintained at a constant speed. Therefore, even when the following vehicle 300 exists relatively near the own vehicle 100, the own vehicle 100 can be autonomously moved so as to maintain the smooth traffic of the vehicles around the own vehicle 100.

Further, when the vehicle driving assistance apparatus 10 determines “No” at the step S435 of the routine shown in FIG. 4, the vehicle driving assistance apparatus 10 proceeds with the process to a step S455 to execute the normal vehicle moving speed control. Then, the vehicle driving assistance apparatus 10 proceeds with the process to the step S495 to terminate executing this routine once.

Next, the routine shown in FIG. 7 will be described.

The power running condition C4 to be determined at the step S440 of the routine shown in FIG. 4 corresponds to a condition that (i) the value of the economy autonomous moving flag X_ECO is “1”, and (ii) the optimum power running control is being executed. That is, the power running condition C4 corresponds to a condition that a deceleration of the own vehicle 100 is not required while the economy autonomous moving control is being executed.

When the vehicle driving assistance apparatus 10 determines “Yes” at the step S440 of the routine shown in FIG. 4 and proceeds with the process to the step S445, the vehicle driving assistance apparatus 10 starts a process from a step S700 of the routine shown in FIG. 7 and proceeds with the process to a step S705 to determine whether a value of a hybrid driving mode flag X_HV is “1”.

The value of the hybrid driving mode flag X_HV is “1” while the own vehicle 100 is being moved at the hybrid driving mode. On the other hand, the value of the hybrid driving mode flag X_HV is “0” while the own vehicle 100 is not moved at the hybrid driving mode. The hybrid driving mode corresponds to a mode of moving the own vehicle 100 by activating both of the internal combustion engine 21 and the electric motor 22 or the internal combustion engine 21 only depending on a required power P_REQ. It should be noted that the required power P_REQ corresponds to the power which is required to be output from the power apparatus 20.

When the vehicle driving assistance apparatus 10 determines “Yes” at the step S705, the vehicle driving assistance apparatus 10 proceeds with the process to a step S710 to set a low efficiency index threshold IX_T to a first low efficiency index threshold IX1 and set a coasting acceleration rate threshold G_T to a first coasting acceleration rate threshold G1. Then, the vehicle driving assistance apparatus 10 proceeds with the process to a step S725. The low efficiency index threshold IX_T corresponds to a threshold used for a determination at the step S725. The coasting acceleration rate threshold G_T corresponds to a threshold used for a determination at a step S735 described later in detail.

On the other hand, when the vehicle driving assistance apparatus 10 determines “No” at the step S705, the vehicle driving assistance apparatus 10 proceeds with the process to a step S715 to determine whether a value of a motor driving mode flag X_EV is “1”.

The value of the motor driving mode flag X_EV is “1” while the own vehicle 100 is being moved at the motor driving mode. On the other hand, the value of the motor driving mode flag X_EV is “0” while the own vehicle 100 is not moved at the motor driving mode. The motor driving mode corresponds to a mode of moving the own vehicle 100 by activating the electric motor 22 only.

When the vehicle driving assistance apparatus 10 determines “Yes” at the step S715, the vehicle driving assistance apparatus 10 proceeds with the process to a step S720 to set the low efficiency index threshold IX_T to a second low efficiency index threshold IX2 and set the coasting acceleration rate threshold G_T to a second coasting acceleration rate threshold G2. Then, the vehicle driving assistance apparatus 10 proceeds with the process to the step S725. It should be noted that the second low efficiency index threshold IX2 is greater than the first low efficiency index threshold IX1, and the second coasting acceleration rate threshold G2 is greater than the first coasting acceleration rate threshold G1.

When the vehicle driving assistance apparatus 10 proceeds with the process to the step S725, the vehicle driving assistance apparatus 10 determines whether a low efficiency condition C5 is satisfied.

The low efficiency condition C5 corresponds to a condition that a moving energy efficiency is smaller than the moving energy efficiency required for moving the own vehicle 100 by the normal vehicle moving speed control in consideration of a road gradient θ when the economy autonomous moving control (i.e., the economy inter-vehicle distance control or the economy vehicle moving speed control) of moving the own vehicle 100 while changing a vehicle moving control (i.e., a control of controlling a moving of the own vehicle 100) between the coasting control and the optimum power running control, is executed. In this regard, the moving energy efficiency corresponds to the energy efficiency of the power apparatus 20 required for moving the own vehicle 100, and the road gradient θ corresponds to a gradient of a road on which the own vehicle 100 is moving.

In the present embodiment, the low efficiency condition C5 corresponds to a condition that a low efficiency index IX is greater than the low efficiency index threshold IX_T as shown by an expression 1 described below.

$$IX > IXth \qquad ( 1 )$$

The low efficiency index IX corresponds to an index which indicates a decreasing degree of the moving energy efficiency (i.e., the energy efficiency of moving the own vehicle 100) when the economy autonomous moving control is executed with respect to the moving energy efficiency when the normal vehicle moving speed control is executed.

In the present embodiment, the low efficiency index IX is acquired by a calculation in accordance with an expression 2 described below.

$$IX = \vert Gd \vert - k \cdot \vert Ga \vert \qquad ( 2 )$$

$$Gd = - F / M + g \cdot sin θ \qquad ( 3 )$$

$$Ga = ( P\_OPT - F ) / M + g \cdot sin θ \qquad ( 4 )$$

In the expression 2, “Gd” represents a coasting acceleration rate (i.e., an acceleration rate of the own vehicle 100 realized by executing the coasting control) and is acquired by a calculation in accordance with an expression 3 described above. The coasting acceleration rate Gd takes a negative value when the own vehicle moving speed V is decreasing. On the other hand, when the own vehicle moving speed V is increasing, the coasting acceleration rate Gd takes a positive value.

Further, in the expression 2, “Ga” represents an optimum power running acceleration rate (i.e., the acceleration rate of the own vehicle 100 realized by executing the optimum power running control) and is acquired by a calculation in accordance with an expression 4 described above. The optimum power running acceleration rate Ga takes a negative value when the own vehicle moving speed V is decreasing. On the other hand, when the own vehicle moving speed V is increasing, the optimum power running acceleration rate Ga takes a positive value.

Further, in the expressions 3 and 4, “F” represents a moving resistance of the own vehicle 100 and for example, is acquired by a calculation in accordance with an expression 5 described below. Furthermore, “M” represents a weight of the own vehicle 100, “g” represents a gravity acceleration rate, and “0” represents the road gradient. Further, “P_OPT” represents an optimum power running power (i.e., the power applied from the power apparatus 20 to the own vehicle 100 when the optimum power running control is executed).

$$F = a \cdot {V}^{2} + b \cdot V + c \qquad ( 5 )$$

In the expression 5, “V” represents the own vehicle moving speed (i.e., the moving speed of the own vehicle 100). Further, “a”, “b”, and “c” are coefficients determined to accurately acquire a moving resistance of the own vehicle 100 based on the own vehicle moving speed V, respectively.

Further, the low efficiency index threshold IX_T (i.e., the first low efficiency index threshold IX1 and the second low efficiency index threshold IX2) are predetermined values. Furthermore, in the expression 1, “k” is a predetermined coefficient. The low efficiency index threshold IX_T and the coefficient K are determined as described below.

That is, the coasting control is executed when a deceleration of the own vehicle 100 is required in a situation where the own vehicle 100 is moved on an even road by the economy autonomous moving control (i.e., the economy inter-vehicle distance control or the economy vehicle moving speed control) of controlling the moving of the own vehicle 100 while switching the coasting control and the optimum power running control. Therefore, the moving energy efficiency is improved compared with when the own vehicle 100 is moved by the normal vehicle moving speed control.

However, when the own vehicle 100 is moved on an upward slope by the economy autonomous moving control, the coasting control and the optimum power running control are frequently switched for a constant period of time. In this case, the moving energy efficiency may be small, compared with when the own vehicle 100 is moved by the normal vehicle moving speed control. In particular, when the own vehicle 100 is autonomously moved at the hybrid driving mode, a process of starting to activate the internal combustion engine 21 and a process of stopping activating the internal combustion engine 21 are frequently switched. In this case, the moving energy efficiency may be low.

Accordingly, in the present embodiment, combinations of the low efficiency index threshold IX_T and the coefficient k which can realize the moving energy efficiency for moving the own vehicle 100 by the economy autonomous moving control which is equal to the moving energy efficiency for moving the own vehicle 100 by the normal vehicle moving speed control in consideration of the road gradient θ, the coasting acceleration rate Gd, and the optimum power running acceleration rate Ga in a situation where the low efficiency index IX is acquired by the calculation in accordance with the expressions 2 to 4, are determined previously by experiments, etc. The low efficiency index threshold IX_T and the coefficient k determined as such are used in the expressions 1 and 2. It should be noted that the coefficient k is greater than zero and equal to or smaller than one.

Therefore, when the low efficiency index IX is greater than the low efficiency index threshold IX_T, the moving energy efficiency for moving the own vehicle 100 by the normal vehicle moving speed control is greater than the moving energy efficiency for moving the own vehicle 100 by the economy autonomous moving control.

From the reasons described above, the vehicle driving assistance apparatus 10 determines which is great, the moving energy efficiency realized by continuing executing the economy autonomous moving control or the moving efficiency realized by stopping executing the economy autonomous moving control and executing the normal vehicle moving speed control at the step S725.

It should be noted that the low efficiency condition C5 also corresponds to an upward slope gradient condition that (i) the economy autonomous moving control is being executed, and (ii) the road gradient θ is greater than a predetermined upward slope gradient threshold θup. In this case, the predetermined upward slope gradient threshold θup corresponds to a gradient realized when an absolute value of a deceleration rate of the own vehicle 100 realized by moving the own vehicle 100 by the coasting control is equal to or greater than a predetermined value or a predetermined deceleration rate threshold in a situation where the road gradient θ is an upward slope gradient. Alternatively, the predetermined upward slope gradient threshold θup corresponds to a gradient realized when the acceleration rate of the own vehicle 100 realized by moving the own vehicle 100 by the optimum power running control is equal to or smaller than a predetermined value or a predetermined acceleration rate threshold in a situation where the road gradient θ is the upward slope gradient. Alternatively, the predetermined upward slope gradient threshold θup corresponds to a gradient realized when a ratio of the absolute value of the coasting acceleration rate Gd to the optimum power running acceleration rate Ga is greater than a predetermined ratio in a situation where the road gradient θ is the upward slope gradient.

Further, the low efficiency index threshold IX_T may be provided with a hysteresis in order to prevent the vehicle moving control from being changed frequently between the economy autonomous moving control and the normal vehicle moving speed control.

Furthermore, when the vehicle moving control is changed from the economy autonomous moving control to the normal vehicle moving speed control in response to the low efficiency condition C5 becoming satisfied, and then it is determined that the preceding vehicle 200 exists while the normal vehicle moving speed control is being executed, the vehicle moving control is changed from the normal vehicle moving speed control to the normal inter-vehicle distance control.

Further, when the vehicle moving control is changed from the economy autonomous moving control to the normal vehicle moving speed control in response to the low efficiency condition C5 becoming satisfied, and then the low efficiency condition C5 becomes unsatisfied, the vehicle moving control is changed from the normal vehicle moving speed control to the economy autonomous moving control. That is, the execution of the economy autonomous moving control is discontinued in response to the low efficiency condition C5 becoming satisfied, and then the examination of the economy autonomous moving control is restarted in response to the low efficiency condition C5 becoming unsatisfied. In this regard, the vehicle driving assistance apparatus 10 may be configured not to restart the economy autonomous moving control even when the low efficiency condition C5 becomes unsatisfied after the economy autonomous moving control in response to the low efficiency condition C5 becoming satisfied.

Further, as shown in FIG. 1, a road gradient acquisition device 62 is installed on the own vehicle 100. The road gradient acquisition device 62 is a device which acquires a gradient of a road on which the own vehicle 100 is moving. The road gradient acquisition device 62 is, for example, a gyroscope. The road gradient acquisition device 62 is electrically connected to the ECU 90. The vehicle driving assistance apparatus 10 acquires the gradient of the road on which the own vehicle 100 is moving as the road gradient θ by the road gradient acquisition device 62.

When the vehicle driving assistance apparatus 10 determines “Yes” at the step S725, the vehicle driving assistance apparatus 10 proceeds with the process to a step S730 to execute the normal vehicle moving speed control. Then, the vehicle driving assistance apparatus 10 proceeds with the process to a step S795 to terminate executing this routine once.

As described above, the vehicle driving assistance apparatus 10 is configured to execute the normal vehicle moving speed control (i.e., the autonomous moving control at a constant speed mode) of maintaining the own vehicle moving speed V at the set vehicle moving speed V_S. Further, the vehicle driving assistance apparatus 10 is configured to stop executing the economy autonomous moving control (i.e., the autonomous moving control at the first moving mode) and execute the normal vehicle moving speed control (i.e., the autonomous moving control at the constant speed mode) when the low efficiency condition C5 (or a second condition) becomes satisfied. In this regard, the low efficiency condition C5 (or the second condition) corresponds to a condition which is likely to be satisfied when the own vehicle 100 moves on the upward slope or the own vehicle 100 moves at a relatively high speed (in particular, the own vehicle 100 moves at a speed equal to or higher than a predetermined vehicle moving speed). Further, the low efficiency index threshold IX_T is set to the first low efficiency index threshold IX1 when the own vehicle 100 is moved at the hybrid driving mode (or the first driving mode), and is set to the second low efficiency index threshold IX2 when the own vehicle 100 is moved at the motor driving mode (or the second driving mode). In addition, the first low efficiency index threshold IX1 is smaller than the second low efficiency index threshold IX2. Therefore, the low efficiency condition C5 (or the second condition) is a condition which is likely to be satisfied when the own vehicle 100 is autonomously moved by the economy autonomous moving control at the hybrid driving mode (or the first driving mode), compared with when the own vehicle 100 is autonomously moved by the economy autonomous moving control at the motor driving mode (or the second driving mode).

When the own vehicle 100 is autonomously moved by the coasting control while the own vehicle 100 is moving on the upward slope or the own vehicle 100 is moving at a high speed, the own vehicle moving speed V may be decreased considerably. In addition, the own vehicle moving speed V may not be increased appropriately even when the own vehicle 100 is autonomously moved by the optimum power running control while the own vehicle 100 is moving on the upward slope or the own vehicle 100 is moving at the high speed. Therefore, when the own vehicle 100 is autonomously moved by the economy autonomous moving control while the own vehicle 100 is moving on the upward slope or the own vehicle 100 is moving at the high speed, an effect of reducing the consumed energy amount may be low.

In addition, the set vehicle moving speed range R_V or the set preceding vehicle distance range R_DF set for autonomously moving the own vehicle 100 by the economy autonomous moving control at the hybrid driving mode, is broader than the set vehicle moving speed range R_V or the set preceding vehicle distance range R_DF set for autonomously moving the own vehicle 100 by the economy autonomous moving control at the motor driving mode. Therefore, when the own vehicle 100 is autonomously moved by the economy autonomous moving control while the own vehicle 100 is moving on the upward slope or the own vehicle 100 is moving at the high speed, the effect of reducing the consumed energy amount may be low.

With the vehicle driving assistance apparatus 10, the low efficiency condition C5 is a condition which is likely to be satisfied when the own vehicle 100 is moving on the upward slope or the own vehicle 100 is moving at the high speed. Further, the low efficiency condition C5 is a condition which is likely to be satisfied when the own vehicle 100 is autonomously moved by the economy autonomous moving control at the hybrid driving mode, compared with when the own vehicle 100 is autonomously moved by the economy autonomous moving control at the motor driving mode. In addition, when the low efficiency condition C5 becomes satisfied, the execution of the economy autonomous moving control is stopped, and the normal vehicle moving speed control is executed. That is, it is likely that the execution of the economy autonomous moving control is stopped, and the normal vehicle moving speed control is executed when the own vehicle 100 is autonomously moved by the economy autonomous moving control at the hybrid driving mode while the own vehicle 100 is moving on the upward slope or the own vehicle 100 is moving at the high speed. Thus, an appropriate level of the effect of reducing the consumed energy amount can be achieved.

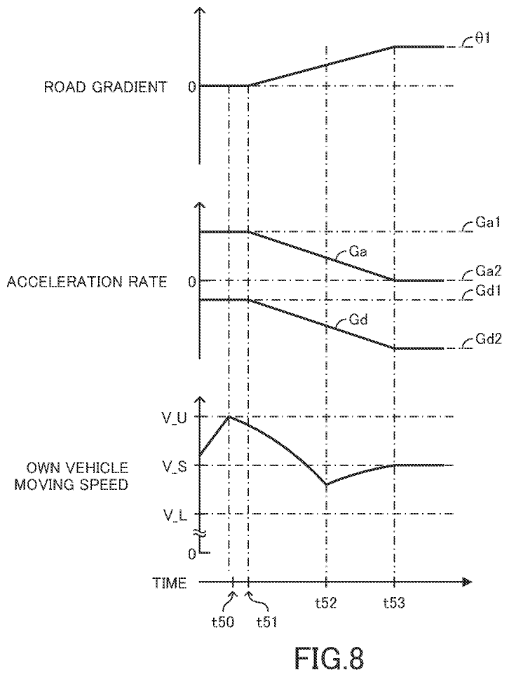

Further, with the vehicle driving assistance apparatus 10, the own vehicle moving speed V is controlled as shown in FIG. 8. In an example shown in FIG. 8, the own vehicle 100 moves on a road having the road gradient θ of zero (i.e., the own vehicle 100 moves on the even road), and the optimum power running control is executed until a point of time t50. Thus, the own vehicle moving speed V gradually increases until the point of time t50. It should be noted that the optimum power running acceleration rate Ga and the coasting acceleration rate Gd are a first optimum power running acceleration rate Ga1 and a first coasting acceleration rate Gd1, respectively until the point of time t50. Further, the first optimum power running acceleration rate Ga1 is a positive value, and the first coasting acceleration rate Gd1 is a negative value.

When the own vehicle moving speed V reaches the upper limit vehicle moving speed V_U at the point of time t50, an execution of the coasting control is started. At the point of time t50, the own vehicle 100 is moving on the road having the road gradient θ of zero. Therefore, the own vehicle 100 is moving on the even road. Thus, the own vehicle moving speed V starts to decrease. It should be noted that the optimum power running acceleration rate Ga and the coasting acceleration rate Gd are also the first optimum power running acceleration rate Ga1 and the first coasting acceleration rate Gd1, respectively at the point of time t50.

Thereafter, the own vehicle 100 starts to move on the upward slope at a point of time t51. In the example shown in FIG. 8, the road gradient θ increases continuously during a period from the point of time t51 to a point of time t53, and stays at a constant value θ1 after the point of time t53. Therefore, the optimum power running acceleration rate Ga and the coasting acceleration rate Gd decrease gradually during a period from the point of time t51 to the point of time t53. In other words, an absolute value of the optimum power running acceleration rate Ga decreases gradually, and an absolute value of the coasting acceleration rate Gd increases gradually. After the point of time t53, the optimum power running acceleration rate Ga and the coasting acceleration rate Gd stay at a second optimum power running acceleration rate Ga2 and a second coasting acceleration rate Gd2, respectively.

The own vehicle moving speed V continues to decrease after the point of time t51. In the example shown in FIG. 8, at a point of time t52, the low efficiency condition C5 becomes satisfied, the execution of the economy autonomous moving control is terminated, and an execution of the normal vehicle moving speed control is started. At the point of time t52, the own vehicle moving speed V is smaller than the set vehicle moving speed V_S. Therefore, the own vehicle 100 is accelerated, and thus the own vehicle moving speed V increases. After the own vehicle moving speed V reaches the set vehicle moving speed V_S, the acceleration rate of the own vehicle 100 is controlled so as to maintain the own vehicle moving speed V at the set vehicle moving speed V_S.

Thereby, when the low efficiency condition C5 becomes satisfied while the economy autonomous moving control is being executed, the execution of the economy autonomous moving control is terminated, and the normal vehicle moving speed control is executed. Therefore, a decreasing of the moving energy efficiency due to a continuation of executing the economy autonomous moving control can be prevented.

On the other hand, when the vehicle driving assistance apparatus 10 determines “No” at the step S725, the vehicle driving assistance apparatus 10 proceeds with the process to a step S735 to determine whether a coasting acceleration rate condition C6 is satisfied.

The coasting acceleration rate condition C6 corresponds to a condition that the own vehicle 100 is moving on a downward slope having a small gradient. In the present embodiment, the coasting acceleration rate condition C6 corresponds to a condition that the coasting acceleration rate Gd is greater than zero as shown by an expression 6 described below, and the absolute value of the coasting acceleration rate Gd is equal to or greater than a coasting acceleration rate threshold G_T as shown by an expression 7 described below.

$$Gd > 0 \qquad ( 6 )$$

$$\vert Gd \vert \geq G\_T \qquad ( 7 )$$

The coasting acceleration rate threshold G_T corresponds to a threshold used for determining whether the own vehicle 100 is moving on the downward slope having a small gradient. In the present embodiment, the coasting acceleration rate threshold G_T is set to a positive value near zero. Therefore, the coasting acceleration rate condition C6 corresponds to a downward slope gradient condition that the road gradient θ is a downward slope gradient which is greater than a predetermined value (or a predetermined downward slope gradient threshold θdown).

When the vehicle driving assistance apparatus 10 determines “Yes” at the step S735, the vehicle driving assistance apparatus 10 proceeds with the process to a step S740 to determine whether a moving speed condition C7 is satisfied.

The moving speed condition C7 corresponds to a condition that the own vehicle moving speed V is smaller than the set vehicle moving speed V_S as shown by an expression 8 described below.

$$V < V\_S \qquad ( 8 )$$

When the vehicle driving assistance apparatus 10 determines “Yes” at the step S740, the vehicle driving assistance apparatus 10 proceeds with the process to a step S745 to execute the coasting control. Then, the vehicle driving assistance apparatus 10 proceeds with the process to the step S795 to terminate executing this routine once.

As described above, when the coasting acceleration rate condition C6 (or the downward slope gradient condition) becomes satisfied, and the own vehicle moving speed V is smaller than the set vehicle moving speed V_S (or a predetermined moving speed), the execution of the economy autonomous moving control is terminated, and the coasting control is executed.

That is, the own vehicle moving speed V increases even when the own vehicle 100 coasts in a situation where (i) the own vehicle 100 is moving on the downward slope having a small gradient, and (ii) the own vehicle moving speed V is smaller than the set vehicle moving speed V_S. Therefore, the vehicle driving assistance apparatus 10 executes the coasting control.

On the other hand, when the vehicle driving assistance apparatus 10 determines “No” at the step S740, the vehicle driving assistance apparatus 10 proceeds with the process to a step S750 to execute the normal vehicle moving speed control. Then, the vehicle driving assistance apparatus 10 proceeds with the process to the step S795 to terminate executing this routine once.

As described above, when the coasting acceleration rate condition C6 (or the downward slope gradient condition) becomes satisfied, and the own vehicle moving speed V is equal to or greater than the set vehicle moving speed V_S (or the predetermined moving speed), the execution of the economy autonomous moving control is terminated, and the normal vehicle moving speed control is executed.

Further, when the own vehicle moving speed V reaches the set vehicle moving speed V_S after the execution of the coasting control is started in response to a determination of “Yes” at the step S740, the vehicle moving speed control is changed from the coasting control to the normal vehicle moving speed control.

As described above, the vehicle driving assistance apparatus 10 is configured to stop executing the economy autonomous moving control (i.e., the autonomous moving control at the first moving mode) and execute the coasting control (i.e., the autonomous moving control by the powering control at the first state) when the coasting acceleration rate condition C6 (or a first condition) becomes satisfied. In this regard, the coasting acceleration rate condition C6 (or the first condition) corresponds to a condition which is likely to be satisfied when the own vehicle 100 moves on the downward slope. Further, the coasting acceleration rate threshold G_T is set to the first coasting acceleration rate threshold G1 when the own vehicle 100 is moved at the hybrid driving mode (or the first driving mode), and is set to the second coasting acceleration rate threshold G2 when the own vehicle 100 is moved at the motor driving mode (or the second driving mode). In addition, the first coasting acceleration rate threshold G1 is smaller than the second coasting acceleration rate threshold G2. Therefore, the coasting acceleration rate condition C6 (or the first condition) is a condition which is likely to be satisfied when the own vehicle 100 is autonomously moved by the economy autonomous moving control at the hybrid driving mode (or the autonomous moving control at the first driving mode), compared with when the own vehicle 100 is autonomously moved by the economy autonomous moving control at the motor driving mode (or the autonomous moving control at the second driving mode).

When the own vehicle 100 is autonomously moved by the coasting control while the own vehicle 100 is moving on the downward slope, the own vehicle moving speed V tends to increase. Therefore, the own vehicle moving speed V increases without executing the optimum power running control to autonomously move the own vehicle 100. Therefore, while the own vehicle 100 is moving on the downward slope, the effect of reducing the consumed energy amount achieved by autonomously moving the own vehicle 100 by the coasting control, is greater than the effect of reducing the consumed energy amount achieved by autonomously moving the own vehicle 100 by the optimum power running control. Further, when the optimum power running control to autonomously move the own vehicle 100 is not executed, the effect of reducing the consumed energy amount achieved by autonomously moving the own vehicle 100 by the economy autonomous moving control at the hybrid driving mode, is greater than the effect of reducing the consumed energy amount achieved by autonomously moving the own vehicle 100 by the economy autonomous moving control at the motor driving mode.

With the vehicle driving assistance apparatus 10, the coasting acceleration rate condition C6 is a condition which is likely to be satisfied when the own vehicle 100 is moving on the downward slope. That is, with the coasting acceleration rate condition C6, it is likely that the execution of the economy autonomous moving control is stopped, and the coasting control is executed while the own vehicle 100 is moving on the downward slope. In addition, the coasting acceleration rate condition C6 is a condition which is unlikely to be satisfied when the own vehicle 100 is autonomously moved by the economy autonomous moving control at the motor driving mode, compared with when the own vehicle 100 is autonomously moved by the economy autonomous moving control at the hybrid driving mode. That is, with the coasting acceleration rate condition C6, it is unlikely that the execution of the economy autonomous moving control is stopped, and the coasting control is executed while the own vehicle 100 is autonomously moved by the economy autonomous moving control at the motor driving mode. Therefore, the great effect of reducing the consumed energy amount can be achieved.

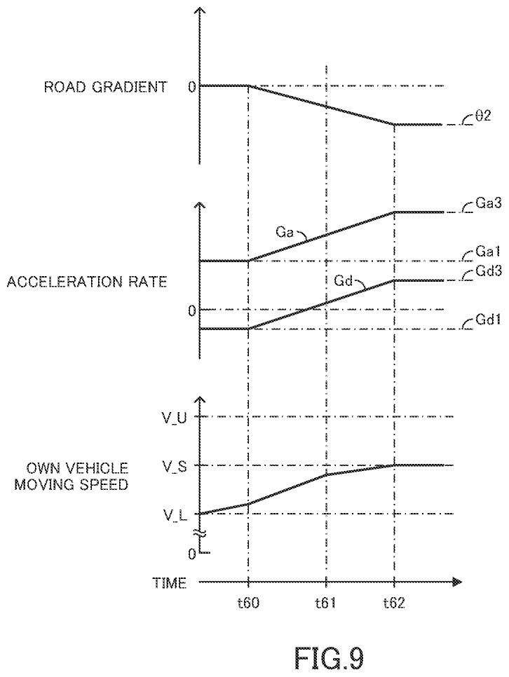

Further, with the vehicle driving assistance apparatus 10, the own vehicle moving speed V is controlled as shown in FIG. 9. In an example shown in FIG. 9, the own vehicle 100 moves on the road having the road gradient θ of zero (i.e., the own vehicle 100 moves on the even road), and the optimum power running control is executed until a point of time t60. Thus, the own vehicle moving speed V gradually increases until the point of time t60. It should be noted that the optimum power running acceleration rate Ga and the coasting acceleration rate Gd are the first optimum power running acceleration rate Ga1 and the first coasting acceleration rate Gd1, respectively until the point of time t60. Further, the first optimum power running acceleration rate Ga1 is a positive value, and the first coasting acceleration rate Gd1 is a negative value.

Thereafter, the own vehicle 100 starts to move on the downward slope at the point of time t60. In the example shown in FIG. 9, the road gradient θ decreases continuously during a period from the point of time t60 to a point of time t62, and stays at a constant value θ2 after the point of time t62. Therefore, the optimum power running acceleration rate Ga and the coasting acceleration rate Gd increase gradually during the period from the point of time t60 to the point of time t62. In other words, the absolute value of the optimum power running acceleration rate Ga increases gradually. On the other hand, the coasting acceleration rate Gd takes a negative value until a point of time t61, and thus the absolute value of the coasting acceleration rate Gd decreases gradually. After the point of time t61, the coasting acceleration rate Gd takes a positive value, and thus the absolute value of the coasting acceleration rate Gd increases gradually. After the point of time t62, the optimum power running acceleration rate Ga and the coasting acceleration rate Gd stay at constant values, i.e., a third optimum power running acceleration rate Ga3 and a third coasting acceleration rate Gd3, respectively.

In the example shown in FIG. 9, an execution of the optimum power running control continues, and the own vehicle 100 moves on the downward slope during a period from the point of time t60 to the point of time t61. Therefore, the own vehicle moving speed V increases at a relatively great increasing rate. Then, at the point of time t61, the coasting acceleration rate condition C6 becomes satisfied. At the point of time t61, the own vehicle moving speed V is smaller than the set vehicle moving speed V_S. Thus, the execution of the economy autonomous moving control is terminated, and the execution of the coasting control is started. Thereby, the increasing rate of the own vehicle moving speed V becomes small, but the own vehicle moving speed V continues increasing.

Thereafter, when the own vehicle moving speed V reaches the set vehicle moving speed V_S at the point of time t62, the execution of the coasting control is terminated, and the execution of the normal vehicle moving speed control is started. Thereby, after the own vehicle moving speed V reaches the set vehicle moving speed V_S, the acceleration rate of the own vehicle 100 is controlled so as to maintain the own vehicle moving speed V at the set vehicle moving speed V_S.

For example, when the own vehicle 100 coasts on the downward slope, the own vehicle 100 is not decelerated, but the own vehicle 100 is accelerated. As a result, the own vehicle moving speed V becomes high excessively. As a result, even when the economy autonomous moving control is executed, the own vehicle moving speed V is not maintained within the set vehicle moving speed range R_V, or the preceding vehicle distance DF is not maintained within the set preceding vehicle distance range R_DF. Under the circumstances, the execution of the economy moving control should not be continued.

With the vehicle driving assistance apparatus 10, when the coasting acceleration rate condition C6 becomes satisfied, the execution of the economy autonomous moving control is terminated. Thus, the continuation of executing the economy autonomous moving control can be prevented when the economy autonomous moving control should not be executed.

Further, when the vehicle driving assistance apparatus 10 determines “No” at the step S735, the vehicle driving assistance apparatus 10 proceeds with the process to the step S505 of the routine shown in FIG. 5 via a step S755 to execute the processes described above. Then, the vehicle driving assistance apparatus 10 terminates executing this routine once.

Further, when the vehicle driving assistance apparatus 10 determines “No” at the step S715, the vehicle driving assistance apparatus 10 proceeds with the process to a step S760 to execute an engine activation continuation control. Then, the vehicle driving assistance apparatus 10 proceeds with the process to the step S795 to terminate executing this routine once. The engine activation continuation control corresponds to a control of moving the own vehicle 100 at an engine driving mode. The engine driving mode corresponds to a mode of continuing activating the internal combustion engine 21.

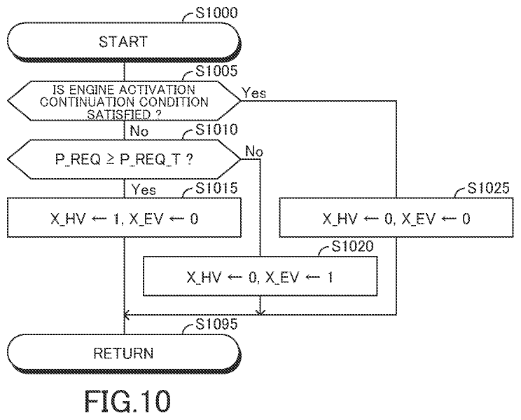

In addition, the vehicle driving assistance apparatus 10 is configured to execute a routine shown in FIG. 10 with the predetermined calculation cycle. Therefore, at a predetermined point of time, the vehicle driving assistance apparatus 10 starts a process from a step S1000 of the routine shown in FIG. 10 and proceeds with the process to a step S1005 to determine whether an engine activation continuation condition C8 is satisfied.

The engine activation continuation condition C8 corresponds to a condition which is satisfied when the activation of the internal combustion engine 21 should be continued. For example, when the battery charge amount of the electricity charge device 41 becomes smaller than a predetermined amount (or a predetermined battery charge amount), and the electricity charge device 41 needs to be charged by activating the internal combustion engine 21, the internal combustion engine 21 should continue to be activated.

When the vehicle driving assistance apparatus 10 determines “No” at the step S1005, the vehicle driving assistance apparatus 10 proceeds with the process to a step S1010 to determine whether the required power P_REQ is equal to or greater than a predetermined required power P_REQ_T.

When the vehicle driving assistance apparatus 10 determines “Yes” at the step S1010, the vehicle driving assistance apparatus 10 proceeds with the process to a step S1015 to set the value of the hybrid driving mode flag X_HV to “1” and set the value of the motor driving mode flag X_EV to “0”. Then, the vehicle driving assistance apparatus 10 proceeds with the process to a step S1095 to terminate executing this routine once. In this case, the own vehicle 100 is moved at the hybrid driving mode.

On the other hand, when the vehicle driving assistance apparatus 10 determines “No” at the step S1010, the vehicle driving assistance apparatus 10 proceeds with the process to a step S1020 to set the value of the hybrid driving mode flag X_HV to “0” and set the value of the motor driving mode flag X_EV to “1”. Then, the vehicle driving assistance apparatus 10 proceeds with the process to the step S1095 to terminate executing this routine once. In this case, the own vehicle 100 is moved at the motor driving mode.

Further, when the vehicle driving assistance apparatus 10 determines “Yes” at the step S1005, the vehicle driving assistance apparatus 10 proceeds with the process to a step S1025 to set the value of the hybrid driving mode flag X_HV to “0” and set the value of the motor driving mode flag X_EV to “0”. Then, the vehicle driving assistance apparatus 10 proceeds with the process to the step S1095 to terminate executing this routine once. In this case, the own vehicle 100 is moved at the engine driving mode.

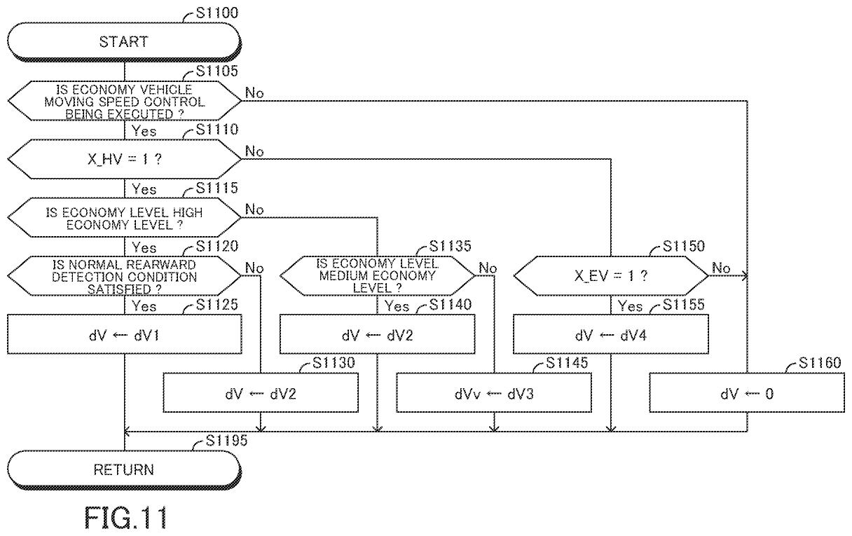

In addition, the vehicle driving assistance apparatus 10 is configured to execute a routine shown in FIG. 11 with the predetermined calculation cycle. Therefore, at a predetermined point of time, the vehicle driving assistance apparatus 10 starts a process from a step S1100 of the routine shown in FIG. 11 and proceeds with the process to a step S1105 to determine whether the economy vehicle moving speed control is being executed.

When the vehicle driving assistance apparatus 10 determines “Yes” at the step S1105, the vehicle driving assistance apparatus 10 proceeds with the process to a step S1110 to determine whether the value of the hybrid driving mode flag X_HV is “1”. That is, the vehicle driving assistance apparatus 10 determines whether the own vehicle 100 is currently moved by the hybrid driving mode.

When the vehicle driving assistance apparatus 10 determines “Yes” at the step S1110, the vehicle driving assistance apparatus 10 proceeds with the process to a step S1115 to determine whether an economy level LV is a high economy level LV_H.

As shown in FIG. 1, an economy level setting operation device 73 such as an economy level setting button is installed on the own vehicle 100. The economy level setting operation device 73 is electrically connected to the ECU 90. The driver can set the economy level LV (or an energy efficiency level) to any of the high economy level LV_H, a medium economy level LV_M, and a low economy level LV_L by operating the economy level setting operation device 73.

The economy level LV corresponds to a level which is requested by the driver as an energy efficiency improvement level (i.e., a level of improving the energy efficiency of the power apparatus 20). When the economy level LV is set to the high economy level LV_H, a maximum energy efficiency improvement level is requested by the driver. When the economy level LV is set to the low economy level LV_L, a minimum energy efficiency improvement level is requested by the driver. When the economy level LV is set to the medium economy level LV_M, the energy efficiency improvement level smaller than the maximum energy efficiency improvement level and greater than the minimum energy efficiency improvement level, is requested by the driver.

As described later in detail, the vehicle driving assistance apparatus 10 is configured to set the set vehicle moving speed range R_V depending on the economy level LV. In general, the vehicle driving assistance apparatus 10 sets the set vehicle moving speed range R_V to a broader range as the economy level LV is higher. Also, the vehicle driving assistance apparatus 10 sets the set preceding vehicle distance range R_DF to a broader range as the economy level LV is higher. In particular, in the present embodiment, the set vehicle moving speed range R_V and the set preceding vehicle distance range R_DF can be changed by a setting operation by the driver of the own vehicle 100 when the own vehicle 100 is moved at the hybrid driving mode.

When the vehicle driving assistance apparatus 10 determines “Yes” at the step S1115, the vehicle driving assistance apparatus 10 proceeds with the process to a step S1120 to determine whether a normal rearward detection condition C9 is satisfied.

The normal rearward detection condition C9 is satisfied when the rearward information detection device 52 can normally function and detect the rearward detection information IR used for detecting the following vehicle 300. Therefore, the normal rearward detection condition C9 is unsatisfied when the rearward information detection device 52 cannot detect the rearward detection information IR used for detecting the following vehicle 300 due to a malfunction of the rearward information detection device 52. It should be noted that the normal rearward detection condition C9 may correspond to a condition which is unsatisfied when the rearward information detection device 52 is not installed on the own vehicle 100.

When the vehicle driving assistance apparatus 10 determines “Yes” at the step S1120, the vehicle driving assistance apparatus 10 proceeds with the process to a step S1125 to set the control vehicle moving speed width dV to a first vehicle moving speed width dV1. Then, the vehicle driving assistance apparatus 10 proceeds with the process to a step S1195 to terminate executing this routine once. The first vehicle moving speed width dV1 is a relatively great value greater than zero.

On the other hand, when the vehicle driving assistance apparatus 10 determines “No” at the step S1120, the vehicle driving assistance apparatus 10 proceeds with the process to a step S1130 to set the control vehicle moving speed width dV to a second vehicle moving speed width dV2. Then, the vehicle driving assistance apparatus 10 proceeds with the process to the step S1195 to terminate executing this routine once. The second vehicle moving speed width dV2 is a value greater than zero, but smaller than the first vehicle moving speed width dV1.

As described above, the vehicle driving assistance apparatus 10 is configured to set the set vehicle moving speed range R_V such that the set vehicle moving speed range R_V set when the normal rearward detection condition C9 is unsatisfied (i.e., a control range change condition that the following vehicle detection device which detects the following vehicle 300 is malfunctioning, is satisfied), is narrower than the set vehicle moving speed range R_V set when the normal rearward detection condition C9 is satisfied (i.e., the control range change condition is unsatisfied) while the economy vehicle moving speed control (or the vehicle moving speed increasing/decreasing control) is being executed.

In other words, the vehicle driving assistance apparatus 10 is configured to set the set vehicle moving speed range R_V (or the set control range) such that the set vehicle moving speed range R_V set when the rearward information detection device 52 (the following vehicle detection device which detects the following vehicle 300) is malfunctioning, is narrower than the set vehicle moving speed range R_V set when the rearward information detection device 52 normally functions while the own vehicle 100 is autonomously moved by the economy vehicle moving speed control at the hybrid driving mode (or the autonomous moving control at the first driving mode).

When the own vehicle moving speed V alternately and excessively increases and decreases in a situation where the own vehicle 100 is autonomously moved by the economy vehicle moving speed control, and the following vehicle 300 exists, the vehicle moving speed of the following vehicle 300 alternately and considerably increases and decreases. As a result, it may disrupt the smooth traffic of vehicles including the following vehicle 300 around the own vehicle 100. Therefore, in order to maintain the smooth traffic of the vehicles around the own vehicle 100 when the own vehicle 100 is autonomously moved by the economy vehicle moving speed control, and the following vehicle 300 exists, the own vehicle 100 should be autonomously moved by the economy vehicle moving speed control in consideration of an existence of the following vehicle 300. In this regard, when the following vehicle 300 cannot be detected due to a malfunction of the rearward information detection device 52, the existence of the following vehicle 300 cannot be considered for executing the economy vehicle moving speed control. Therefore, the own vehicle 100 cannot be autonomously moved so as to maintain the smooth traffic of the vehicles around the own vehicle 100.

With the vehicle driving assistance apparatus 10, the set vehicle moving speed range R_V set when the rearward information detection device 52 is malfunctioning, is narrower than the set vehicle moving speed range R_V set when the rearward information detection device 52 normally functions. Thereby, the own vehicle moving speed V can be prevented from alternately and excessively increasing and decreasing. Therefore, the own vehicle 100 can be autonomously moved by the economy vehicle moving speed control without disrupting the smooth traffic of the vehicles around the own vehicle 100 when the following vehicle 300 cannot be detected.

Further, when the vehicle driving assistance apparatus 10 determines “No” at the step S1115, the vehicle driving assistance apparatus 10 proceeds with the process to a step S1135 to determine whether the economy level LV is the medium economy level LV_M.

When the vehicle driving assistance apparatus 10 determines “Yes” at the step S1135, the vehicle driving assistance apparatus 10 proceeds with the process to a step S1140 to set the control vehicle moving speed width dV to the second vehicle moving speed width dV2. Then, the vehicle driving assistance apparatus 10 proceeds with the process to the step S1195 to terminate executing this routine once.

On the other hand, when the vehicle driving assistance apparatus 10 determines “No” at the step S1135, the vehicle driving assistance apparatus 10 proceeds with the process to a step S1145 to set the control vehicle moving speed width dV to a third vehicle moving speed width dV3. Then, the vehicle driving assistance apparatus 10 proceeds with the process to the step S1195 to terminate executing this routine once. The third vehicle moving speed width dV3 is greater than zero and is smaller than the second vehicle moving speed width dV2.

When the vehicle driving assistance apparatus 10 determines “No” at the step S1110, the vehicle driving assistance apparatus 10 proceeds with the process to a step S1150 to determine whether the value of the motor driving mode flag X_EV is “1”.

When the vehicle driving assistance apparatus 10 determines “Yes” at the step S1150, the vehicle driving assistance apparatus 10 proceeds with the process to a step S1155 to set the control vehicle moving speed width dV to a fourth vehicle moving speed width dV4. Then, the vehicle driving assistance apparatus 10 proceeds with the process to the step S1195 to terminate executing this routine once. The fourth vehicle moving speed width dV4 is greater than zero and is smaller than the third vehicle moving speed width dV3.

As described above, the vehicle driving assistance apparatus 10 is configured to execute the economy vehicle moving speed control at any of the hybrid driving mode (or the first driving mode) and the motor driving mode (or the second driving mode). The economy vehicle moving speed control at the hybrid driving mode corresponds to a control of moving the own vehicle 100 by activating both of the internal combustion engine 21 and the electric motor 22 or the internal combustion engine 21 only and applying the power to the own vehicle 100. The economy vehicle moving speed control at the motor driving mode corresponds to a control of moving the own vehicle 100 by activating the electric motor 22 only and applying the power to the own vehicle 100.

In this regard, the set vehicle moving speed range R_V used for executing the economy vehicle moving speed control (or the vehicle moving speed increasing/decreasing control) at the motor driving mode (or the second driving mode), is narrower than the set vehicle moving speed range R_V used for executing the economy vehicle moving speed control at the hybrid driving mode (or the first driving mode).

Further, a condition for decreasing the control vehicle moving speed width dV includes a condition that the economy vehicle moving speed control (or the vehicle moving speed increasing/decreasing control) is being executed at the hybrid driving mode (or the first driving mode). In this regard, the vehicle driving assistance apparatus 10 is configured not to change the set vehicle moving speed range R_V even when the normal rearward detection condition C9 is unsatisfied in a situation where the economy vehicle moving speed control is being executed at the motor driving mode (or the second driving mode).

In other words, the vehicle driving assistance apparatus 10 is configured not to change the control vehicle moving speed width dV (or the set control range) even when a malfunction of the rearward information detection device 52 (the following vehicle detection device which detects the following vehicle 300) occurs while the vehicle driving assistance apparatus 10 is executing the economy vehicle moving speed control at the motor driving mode (or the autonomous moving control at the second driving mode).

With the vehicle driving assistance apparatus 10, when the own vehicle 100 is autonomously moved by the economy vehicle moving speed control at the motor driving mode, the set vehicle moving speed range R_V is relatively narrow. Therefore, the own vehicle moving speed V does not alternately and excessively increase and decrease even when the own vehicle 100 continues being moved by the economy vehicle moving speed control without changing the set vehicle moving speed range R_V in a situation where the following vehicle 300 cannot be detected due to a malfunction of the rearward information detection device 52. Therefore, the following vehicle 300 does not change its vehicle moving speed considerably. Thus, there is a low possibility of disrupting the smooth traffic of the vehicles around the own vehicle 100. Therefore, the own vehicle 100 can be autonomously moved by the economy vehicle moving speed control so as to maintain the smooth traffic of the vehicles around the own vehicle 100 without changing the set vehicle moving speed range R_V.

Further, the vehicle driving assistance apparatus 10 is configured to set the control vehicle moving speed width dV (or the set control range) such that the control vehicle moving speed width dV used by the economy vehicle moving speed control at the driving mode corresponding to the hybrid driving mode (i.e., the first driving mode capable of using the power other than the power generated by the electricity of the electricity charge device 41), is greater than the control vehicle moving speed width dV used by the economy vehicle moving speed control at the driving mode corresponding to the motor driving mode (i.e., the second driving mode of using the power generated by the electricity of the electricity charge device 41 only).

Furthermore, the vehicle driving assistance apparatus 10 is configured to set the set vehicle moving speed range R_V such that the set vehicle moving speed range R_V set when the vehicle driving assistance apparatus 10 autonomously moves the own vehicle 100 by the economy vehicle moving speed control at the hybrid driving mode (i.e., the vehicle moving speed increasing/decreasing control at the first driving mode), is broader than the set vehicle moving speed range R_V set when the vehicle driving assistance apparatus 10 autonomously moves the own vehicle 100 by the economy vehicle moving speed control at the motor driving mode (i.e., the vehicle moving speed increasing/decreasing control at the second driving mode) in a situation where the vehicle driving assistance apparatus 10 executes the economy vehicle moving speed control (i.e., the vehicle moving speed increasing/decreasing control) by selectively executing the coasting control (i.e., the power control at the first state) and the optimum power running control (i.e., the power control at the second state), and the normal rearward detection condition C9 is satisfied.

When the own vehicle 100 is moved by the autonomous moving control, in particular, the own vehicle 100 is autonomously moved by the economy vehicle moving speed control at the hybrid driving mode by selectively executing the coasting control and the optimum power running control, the broad set vehicle moving speed range R_V may generally increase the effect of reducing the consumed energy amount. However, when the own vehicle 100 is autonomously moved by the economy vehicle moving speed control at the motor driving mode, the broad set vehicle moving speed range R_V does not much increase the effect of reducing the consumed energy amount, but may increase a likelihood of disrupting the smooth traffic of the vehicles around the own vehicle 100.

With the vehicle driving assistance apparatus 10, the set vehicle moving speed range R_V set when the driving mode is the hybrid driving mode, is broader than the set vehicle moving speed range R_V set when the driving mode is the motor driving mode in a situation where the own vehicle 100 is autonomously moved by the economy vehicle moving speed control by selectively executing the coasting control and the optimum power running control, and the normal rearward detection condition C9 is satisfied. Therefore, the smooth traffic of the vehicles around the own vehicle 100 can be maintained, and a certain level of the effect of reducing the consumed energy amount can be realized.

On the other hand, when the vehicle driving assistance apparatus 10 determines “No” at the step S1150, the vehicle driving assistance apparatus 10 proceeds with the process to a step S1160 to set the control vehicle moving speed width dV to zero. Then, the vehicle driving assistance apparatus 10 proceeds with the process to the step S1195 to terminate executing this routine once. In this case, the driving mode is nether the hybrid driving mode nor the motor driving mode. Therefore, as described above, the engine activation continuation control is executed.

Further, when the vehicle driving assistance apparatus 10 determines “No” at the step S1105, the vehicle driving assistance apparatus 10 proceeds with the process to the step S1160 to set the control vehicle moving speed width dV to zero. Then, the vehicle driving assistance apparatus 10 proceeds with the process to the step S1195 to terminate executing this routine once. In this case, when the preceding vehicle 200 does not exists, the normal vehicle moving speed control is executed.

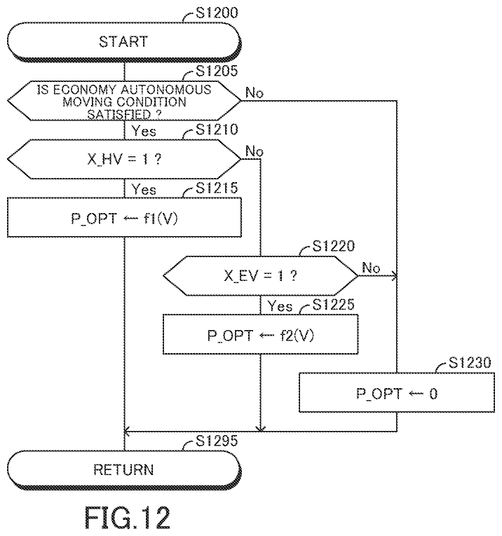

Further, the vehicle driving assistance apparatus 10 is configured to execute a routine shown in FIG. 12 with the predetermined calculation cycle. Therefore, at a predetermined point of time, the vehicle driving assistance apparatus 10 starts a process from a step S1200 and proceeds with the process to a step S1205 to determine whether the economy autonomous moving condition C3 is satisfied. That is, the vehicle driving assistance apparatus 10 determines whether it is executing the economy autonomous moving control.

When the vehicle driving assistance apparatus 10 determines “Yes” at the step S1205, the vehicle driving assistance apparatus 10 proceeds with the process to a step S1210 to determine whether the value of the hybrid driving mode flag X_HV is “1”. That is, the vehicle driving assistance apparatus 10 determines whether the driving mode is the hybrid driving mode.

When the vehicle driving assistance apparatus 10 determines “Yes” at the step S1210, the vehicle driving assistance apparatus 10 proceeds with the process to a step S1215 to set the optimum power running power P_OPT based on the own vehicle moving speed V. Then, the vehicle driving assistance apparatus 10 proceeds with the process to a step S1295 to terminate executing this routine once. In this case, the economy autonomous moving control is executed based on the optimum power running power P_OPT set at the step S1215.

On the other hand, when the vehicle driving assistance apparatus 10 determines “No” at the step S1210, the vehicle driving assistance apparatus 10 proceeds with the process to a step S1220 to determine whether the value of the motor driving mode flag X_EV is “1”. That is, the vehicle driving assistance apparatus 10 determines whether the driving mode is the motor driving mode.

When the vehicle driving assistance apparatus 10 determines “Yes” at the step S1220, the vehicle driving assistance apparatus 10 proceeds with the process to a step S1225 to set the optimum power running power P_OPT based on the own vehicle moving speed V. Then, the vehicle driving assistance apparatus 10 proceeds with the process to the step S1295 to terminate executing this routine once. In this case, the economy autonomous moving control is executed based on the optimum power running power P_OPT set at the step S1225.

On the other hand, when the vehicle driving assistance apparatus 10 determines “No” at the step S1220, the vehicle driving assistance apparatus 10 proceeds with the process to a step S1230 to set the optimum power running power P_OPT to zero. Then, the vehicle driving assistance apparatus 10 proceeds with the process to the step S1295 to terminate executing this routine once. In this case, the driving mode is nether the hybrid driving mode nor the motor driving mode. Therefore, as described above, the engine activation continuation control is executed.

Further, also when the vehicle driving assistance apparatus 10 determines “No” at the step S1205, the vehicle driving assistance apparatus 10 proceeds with the process to the step S1230 to set the optimum power running power P_OPT to zero. Then, the vehicle driving assistance apparatus 10 proceeds with the process to the step S1295 to terminate executing this routine once. In this case, the economy autonomous moving condition C3 is not satisfied. Therefore, the normal autonomous moving control is executed.

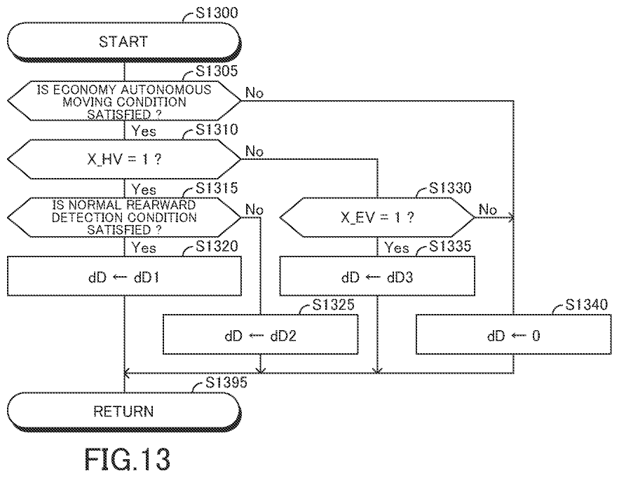

Further, the vehicle driving assistance apparatus 10 is configured to execute a routine shown in FIG. 13 with the predetermined calculation cycle. Therefore, at a predetermined point of time, the vehicle driving assistance apparatus 10 starts a process from a step S1300 and proceeds with the process to a step S1305 to determine whether the economy autonomous moving condition C3 is satisfied. That is, the vehicle driving assistance apparatus 10 determines whether it is currently executing the economy autonomous moving control.

When the vehicle driving assistance apparatus 10 determines “Yes” at the step S1305, the vehicle driving assistance apparatus 10 proceeds with the process to a step S1305 to determine the value of the hybrid driving mode flag X_HV is “1”. That is, the vehicle driving assistance apparatus 10 determines whether it is currently moving the own vehicle 100 at the hybrid driving mode.

When the vehicle driving assistance apparatus 10 determines “Yes” at the step S1310, the vehicle driving assistance apparatus 10 proceeds with the process to a step S1315 to determine whether the normal rearward detection condition C9 is satisfied.

When the vehicle driving assistance apparatus 10 determines “Yes” at the step S1315, the vehicle driving assistance apparatus 10 proceeds with the process to a step S1320 to set the control inter-vehicle distance width dD to a first inter-vehicle distance width dD1. Then, the vehicle driving assistance apparatus 10 proceeds with the process to a step S1395 to terminate executing this routine once. The first inter-vehicle distance width dD1 is a relatively great value greater than zero. In this case, the economy inter-vehicle distance control is executed based on the set preceding vehicle distance range R_DF set based on the first inter-vehicle distance width dD1.

On the other hand, when the vehicle driving assistance apparatus 10 determines “No” at the step S1315, the vehicle driving assistance apparatus 10 proceeds with the process to a step S1325 to set the control inter-vehicle distance width dD to a second inter-vehicle distance width dD2. Then, the vehicle driving assistance apparatus 10 proceeds with the process to the step 1395 to terminate executing this routine once. The second inter-vehicle distance width dD2 is greater than zero and is smaller than the first inter-vehicle distance width dD1. In this case, the economy inter-vehicle distance control is executed based on the set preceding vehicle distance range R_DF set based on the second inter-vehicle distance width dD2 smaller than the first inter-vehicle distance width dD1.

As described above, the vehicle driving assistance apparatus 10 is configured to set the set preceding vehicle distance range R_DF such that the set preceding vehicle distance range R_DF set when the normal rearward detection condition C9 is unsatisfied (i.e., the control range change condition that the following vehicle detection apparatus which detects the following vehicle 300 is malfunctioning, is satisfied), is narrower than the set preceding vehicle distance range R_DF set when the normal rearward detection condition C9 is satisfied (i.e., the control range change condition is unsatisfied) while the vehicle driving assistance apparatus 10 is executing the economy inter-vehicle distance control (i.e. the inter-vehicle distance increasing/decreasing control).

In other words, the vehicle driving assistance apparatus 10 is configured to set the set preceding vehicle distance range R_DF (i.e., the set control range) such that the set preceding vehicle distance range R_DF set when the rearward information detection device 52 (i.e., the following vehicle detection device which detects the following vehicle 300) is malfunctioning, is narrower than the set preceding vehicle distance range R_DF set when the rearward information detection device 52 normally functions while the vehicle driving assistance apparatus 10 is autonomously moving the own vehicle 100 by the economy inter-vehicle distance control at the hybrid driving mode (i.e., the autonomous moving control at the first driving mode).

When the following vehicle 300 exists, and the preceding vehicle distance DF varies excessively and considerably while the own vehicle 100 is autonomously moved by the economy inter-vehicle distance control, the following vehicle 300 may change its moving speed considerably. Thereby, the smooth traffic of the vehicles including the following vehicle 300 around the own vehicle 100 may be disrupted. Therefore, in order to maintain the smooth traffic of the vehicles around the own vehicle 100, the economy inter-vehicle distance control should be executed to autonomously move the own vehicle 100 in consideration of the existence of the following vehicle 300. However, when the following vehicle 300 cannot be detected due to the malfunction of the rearward information detection device 52, the economy inter-vehicle distance control cannot be executed in consideration of the existence of the following vehicle 300. Therefore, the own vehicle 100 cannot be moved by the economy inter-vehicle distance control so as to maintain the smooth traffic of the vehicle around the own vehicle 100.

With the vehicle driving assistance apparatus 10, the set preceding vehicle distance range R_DF set when the rearward information detection device 52 is malfunctioning, is narrower than the set preceding vehicle distance range R_DF set when the rearward information detection device 52 normally functions. Thereby, excessive variation of the preceding vehicle distance DF can be prevented. Therefore, the own vehicle 100 can be autonomously moved by the economy inter-vehicle distance control without disrupting the smooth traffic of the vehicles around the own vehicle 100 when the rearward information detection device 52 is malfunctioning.

Further, when the vehicle driving assistance apparatus 10 determines “No” at the step S1310, the vehicle driving assistance apparatus 10 proceeds with the process to a step S1330 to determine whether the value of the motor driving mode flag X_EV is “1”. That is, the vehicle driving assistance apparatus 10 determines whether it is currently moving the own vehicle 100 at the motor driving mode.

When the vehicle driving assistance apparatus 10 determines “Yes” at the step S1330, the vehicle driving assistance apparatus 10 proceeds with the process to a step S1335 to set the control inter-vehicle distance width dD to a third inter-vehicle distance width dD3. Then, the vehicle driving assistance apparatus 10 proceeds with the process to the step S1395 to terminate executing this routine once. The third inter-vehicle distance width dD3 is greater than zero and is smaller than the second inter-vehicle distance width dD2. In this case, the economy inter-vehicle distance control is executed based on the set preceding vehicle distance range R_DF set based on the third inter-vehicle distance width dD3 smaller than the second inter-vehicle distance width dD2.

As can be understood from the above description, the vehicle driving assistance apparatus 10 is configured to execute the economy inter-vehicle distance control (i.e., the inter-vehicle distance increasing/decreasing control) at any one of the hybrid driving mode (i.e., the first driving mode) and the motor driving mode (i.e., the second driving mode). In this regard, the hybrid driving mode corresponds to a mode of moving the own vehicle 100 by applying the power to the own vehicle 100 by activating both of the internal combustion engine 21 and the electric motor 22 or the internal combustion engine 21 only. On the other hand, the motor driving mode corresponds to a mode of moving the own vehicle 100 by applying the power to the own vehicle 100 by activating the electric motor 22 only.

Further, the set preceding vehicle distance range R_DF set when the economy inter-vehicle distance control is executed at the hybrid driving mode (i.e., the first driving mode), is narrower than the economy inter-vehicle distance control is executed at the motor driving mode (i.e., the second driving mode).

Furthermore, a condition for setting the smaller control inter-vehicle distance width dD includes a condition that the economy inter-vehicle distance control (i.e., the inter-vehicle distance increasing/decreasing control) is executed at the hybrid driving mode (i.e., the first driving mode). In addition, the vehicle driving assistance apparatus 10 is configured not to change the set preceding vehicle distance range R_DF (i.e., the set inter-vehicle distance range) even when the normal rearward detection condition C9 is unsatisfied (i.e., the control range change condition is satisfied) in a situation where the vehicle driving assistance apparatus 10 executes the economy inter-vehicle distance control (i.e., the inter-vehicle distance increasing/decreasing control) at the motor driving mode (i.e., the second driving mode).

In other words, the vehicle driving assistance apparatus 10 is configured not to change the control inter-vehicle distance width dD (i.e., the set control range) even when the rearward information detection device 52 (i.e., the following vehicle detection device which detects the following vehicle 300) is malfunctioning while the vehicle driving assistance apparatus 10 executes the economy inter-vehicle distance control at the motor driving mode (i.e., the second driving mode).

With the vehicle driving assistance apparatus 10, the set preceding vehicle distance range R_DF is relatively narrow when the own vehicle 100 is autonomously moved by the economy inter-vehicle distance control at the motor driving mode. Therefore, the preceding vehicle distance DF does not vary excessively and considerably even by continuing autonomously moving the own vehicle 100 by the economy inter-vehicle distance control without changing the set preceding vehicle distance range R_DF in a situation where the following vehicle 300 cannot be detected due to the malfunction of the rearward information detection device 52. Therefore, the following vehicle 300 does not vary its moving speed considerably. Thus, there is a low possibility of disrupting the smooth traffic of the vehicles around the own vehicle 100. Therefore, the own vehicle 100 can be autonomously moved by the economy inter-vehicle distance control so as to maintain the smooth traffic of the vehicles around the own vehicle 100 even without changing the set preceding vehicle distance range R_DF.

Further, the vehicle driving assistance apparatus 10 is configured to set the control inter-vehicle distance width dD (i.e., the set control range) such that the control inter-vehicle distance width dD set when the driving mode is the hybrid driving mode (i.e., the first driving mode capable of using the power other than the power generated by the electricity of the electricity charge device 41), is greater than the control inter-vehicle distance width dD set when the driving mode is the motor driving mode (i.e., the second driving mode of using the power generated by the electricity of the electricity charge device 41 only) while the vehicle driving assistance apparatus 10 is executing the economy inter-vehicle distance control.

Further, the vehicle driving assistance apparatus 10 is configured to set the set preceding vehicle distance range R_DF (i.e., the set inter-vehicle distance range) such that the set preceding vehicle distance range R_DF set when the vehicle driving assistance apparatus 10 autonomously moves the own vehicle 100 by the economy inter-vehicle distance control at the hybrid driving mode (i.e., the inter-vehicle distance increasing/decreasing control at the first driving mode), is broader than the set preceding vehicle distance range R_DF set when the vehicle driving assistance apparatus 10 autonomously moves the own vehicle 100 by the economy inter-vehicle distance control at the motor driving mode (i.e., the inter-vehicle distance increasing/decreasing control at the second driving mode) while the vehicle driving assistance apparatus 10 is executing the economy inter-vehicle distance control (i.e., the inter-vehicle distance increasing/decreasing control) by selectively executing the coasting control (i.e., the power control at the first state) and the optimum power running control (i.e., the power control at the second state), and the normal rearward detection condition C9 is satisfied (i.e. the control range change condition is unsatisfied).

When the set preceding vehicle distance range R_DF is broad, and the autonomous moving control is executed (i.e., the own vehicle 100 is autonomously moved by the economy inter-vehicle distance control at the hybrid driving mode by selectively executing the coasting control and the optimum power running control), the effect of reducing the consumed energy amount is generally great. However, when the own vehicle 100 is autonomously moved by the economy inter-vehicle distance control at the motor driving mode, the broad set preceding vehicle distance range R_DF does not much increase the effect of reducing the consumed energy amount, but may increase a likelihood of disrupting the smooth traffic of the vehicles around the own vehicle 100.

With the vehicle driving assistance apparatus 10, the set preceding vehicle distance range R_DF set when the driving mode is the hybrid driving mode, is broader than the set preceding vehicle distance range R_DF set when the driving mode is the motor driving mode in a situation where the own vehicle 100 is autonomously moved by the economy inter-vehicle distance control by selectively executing the coasting control and the optimum power running control, and the normal rearward detection condition C9 is satisfied. Therefore, the smooth traffic of the vehicles around the own vehicle 100 can be maintained, and a certain level of the effect of reducing the consumed energy amount can be realized.

On the other hand, when the vehicle driving assistance apparatus 10 determines “No” at the step S1330, the vehicle driving assistance apparatus 10 proceeds with the process to a step S1340 to set the control inter-vehicle distance width dD to zero. Then, the vehicle driving assistance apparatus 10 proceeds with the process to the step S1395 to terminate executing this routine once. In this case, the driving mode is nether the hybrid driving mode nor the motor driving mode. Therefore, as described above, the engine activation continuation control is executed.

Further, when the vehicle driving assistance apparatus 10 determines “No” at the step S1305, the vehicle driving assistance apparatus 10 proceeds with the process to the step S1340 to set the control inter-vehicle distance width dD to zero. Then, the vehicle driving assistance apparatus 10 proceeds with the process to the step S1395 to terminate executing this routine once.

It should be noted that the present invention is not limited to the aforementioned embodiments, and various modifications can be employed within the scope of the invention.

For example, the vehicle driving assistance apparatus 10 may be configured to execute the economy vehicle moving speed control when the own vehicle moving speed V increases and reaches an upper limit vehicle moving speed V_U described later in detail while the vehicle driving assistance apparatus 10 is executing the economy inter-vehicle distance control.

Further, in a situation where the following vehicle 300 exists as shown in FIG. 3A, the vehicle driving assistance apparatus 10 may be configured to execute the optimum power running control to accelerate the own vehicle 100 when the preceding vehicle distance DF is smaller than the upper limit preceding vehicle distance DF_U, but the following vehicle distance DR becomes equal to or smaller than the predetermined following vehicle distance DR_T while the vehicle driving assistance apparatus 10 is executing the economy inter-vehicle distance control. In this case, the vehicle driving assistance apparatus 10 starts to execute the optimum power running control, and then continues executing the optimum power running control until the preceding vehicle distance DF reaches the lower limit preceding vehicle distance DF_L even when the following vehicle distance DR becomes greater than the predetermined following vehicle distance DR_T.

Further, in a situation where the following vehicle 300 exists, the vehicle driving assistance apparatus 10 may be configured to determine a point of time of starting to execute the optimum power running control so as to prevent the own vehicle 100 from being too close to the following vehicle 300 in consideration of a difference between the own vehicle moving speed V and the moving speed of the following vehicle 300 while the vehicle driving assistance apparatus 10 is executing the economy inter-vehicle distance control.

It should be noted that in a situation where the following vehicle 300 which is another vehicle around the own vehicle 100, exists as shown in FIG. 3B, the vehicle driving assistance apparatus 10 may be configured to execute the optimum power running control to accelerate the own vehicle 100 when the own vehicle moving speed V is greater than the lower limit vehicle moving speed V_L, but the following vehicle distance DR (i.e., a distance between the own vehicle 100 and the following vehicle 300) becomes equal to or smaller than a predetermined distance or the predetermined following vehicle distance DR_T while the vehicle driving assistance apparatus 10 is executing the economy vehicle moving speed control. In this case, the vehicle driving assistance apparatus 10 starts to execute the optimum power running control, and then continues executing the optimum power running control until the own vehicle moving speed V reaches the upper limit vehicle moving speed V_U even when the following vehicle distance DR becomes greater than the predetermined following vehicle distance DR_T.

Further, in a situation where the following vehicle 300 exists, the vehicle driving assistance apparatus 10 may be configured to determine a point of time of starting to execute the optimum power running control so as to prevent the own vehicle 100 from being too close to the following vehicle 300 in consideration of the difference between the own vehicle moving speed V and the moving speed of the following vehicle 300 while the vehicle driving assistance apparatus 10 is executing the economy vehicle moving speed control.

What is claimed is:

1. A vehicle driving assistance apparatus, comprising an electronic control unit which is configured to execute at least one of a vehicle moving speed increasing/decreasing control and an inter-vehicle distance increasing/decreasing control,
the vehicle moving speed control corresponding to a control of autonomously moving an own vehicle while alternately increasing and decreasing a vehicle moving speed of the own vehicle within a set vehicle moving speed range, and
the inter-vehicle distance increasing/decreasing control corresponding to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range,
wherein the electronic control unit is configured to:
while executing the vehicle moving speed increasing/decreasing control, set the set vehicle moving speed range such that the set vehicle moving speed range set when a control range change condition is satisfied, is narrower than the set vehicle moving speed range set when the control range change condition is unsatisfied,
the control range change condition corresponding to a condition that a following vehicle detection device which detects a following vehicle, is malfunctioning; and
while executing the inter-vehicle distance increasing/decreasing control, set the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.

2. The vehicle driving assistance apparatus as claimed in claim 1,
wherein the electronic control unit is configured to execute at least one of a vehicle moving speed maintaining control and an inter-vehicle distance maintaining control,
the vehicle moving speed maintaining control corresponds to a control of autonomously moving the own vehicle while maintaining the vehicle moving speed at a set vehicle moving speed, and
the inter-vehicle distance maintaining control corresponds to a control of autonomously moving the own vehicle while maintaining the inter-vehicle distance at a set inter-vehicle distance or maintaining the period of time required for the own vehicle to move the inter-vehicle distance at a set period of time, and
wherein the electronic control unit is configured to:
when a moving mode change condition becomes satisfied while executing the vehicle moving speed increasing/decreasing control, stop executing the vehicle moving speed increasing/decreasing control and execute the vehicle moving speed maintaining control,
the moving mode change condition corresponding to a condition that (i) the following vehicle detection device normally functions, (ii) the following vehicle is detected, and (iii) a distance between the detected following vehicle and the own vehicle is equal to or smaller than a predetermined distance, or a period of time required for the detected following vehicle to move the distance between the detected following vehicle and the own vehicle, is equal to or smaller than a predetermined period of time; and
when the moving mode change condition becomes satisfied while executing the inter-vehicle distance increasing/decreasing control, stop executing the inter-vehicle distance increasing/decreasing control and execute the inter-vehicle distance maintaining control.

3. The vehicle driving assistance apparatus as claimed in claim 1,
wherein the electronic control unit is configured to execute at least one of the vehicle moving speed increasing/decreasing control and the inter-vehicle distance increasing/decreasing control at any of a first driving mode and a second driving mode,
the first driving mode corresponds to a mode of moving the own vehicle by activating both of an internal combustion engine and an electric motor or by activating the internal combustion engine only to apply a power to the own vehicle,
the second driving mode corresponds to a mode of moving the own vehicle by activating the electric motor only to apply the power to the own vehicle,
the set vehicle moving speed range set when the vehicle moving speed increasing/decreasing control is executed at the second driving mode, is narrower than the set vehicle moving speed range set when the vehicle moving speed increasing/decreasing control is executed at the first driving mode,
the set inter-vehicle distance range set when the inter-vehicle distance increasing/decreasing control is executed at the second driving mode, is narrower than the set inter-vehicle distance range set when the inter-vehicle distance increasing/decreasing control is executed at the first driving mode,
the control range change condition includes a condition that the vehicle moving speed increasing/decreasing control or the inter-vehicle distance increasing/decreasing control is executed at the first driving mode, and
the electronic control unit is configured not to change the set vehicle moving speed range or the set inter-vehicle distance range or the set period-of-time range even when the control range change condition becomes satisfied while executing the vehicle moving speed increasing/decreasing control or the inter-vehicle distance increasing/decreasing control at the second driving mode.

4. The vehicle driving assistance apparatus as claimed in claim 3,
wherein the electronic control unit is configured to execute the vehicle moving speed increasing/decreasing control or the inter-vehicle distance increasing/decreasing control while selectively executing a power control at a first state and a power control at a second state,
the first state corresponds to a state of reducing a power generation loss in a power apparatus of the own vehicle or a power transmission loss from the power apparatus to driven wheels of the own vehicle,
the second state corresponds to a state of mechanically or electrically connecting the power apparatus to the driven wheels and applying the power to the driven wheels, and
the electronic control unit is configured to set the set vehicle moving speed range or the set inter-vehicle distance range such that the set vehicle moving speed range or the set inter-vehicle distance range or the set period-of-time range set when autonomously moving the own vehicle by the vehicle moving speed increasing/decreasing control or the inter-vehicle distance increasing/decreasing control at the first driving mode, is broader than the set vehicle moving speed range or the set inter-vehicle distance range or the set period-of-time range set when autonomously moving the own vehicle by the vehicle moving speed increasing/decreasing control or the inter-vehicle distance increasing/decreasing control at the second driving mode in a situation where (i) the electronic control unit is executing the vehicle moving speed increasing/decreasing control or the inter-vehicle distance increasing/decreasing control while selectively executing the power control at the first state and the power control at the second state, and (ii) the control range change condition is unsatisfied.

5. A vehicle driving assistance method of executing at least one of a vehicle moving speed increasing/decreasing control and an inter-vehicle distance increasing/decreasing control,
the vehicle moving speed control corresponding to a control of autonomously moving an own vehicle while alternately increasing and decreasing a vehicle moving speed of the own vehicle within a set vehicle moving speed range, and
the inter-vehicle distance increasing/decreasing control corresponding to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range,
wherein the vehicle driving assistance method comprises steps of:
while executing the vehicle moving speed increasing/decreasing control, setting the set vehicle moving speed range such that the set vehicle moving speed range set when a control range change condition is satisfied, is narrower than the set vehicle moving speed range set when the control range change condition is unsatisfied,
the control range change condition corresponding to a condition that a following vehicle detection device which detects a following vehicle, is malfunctioning; and
while executing the inter-vehicle distance increasing/decreasing control, setting the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.

6. A computer-readable storage medium storing a vehicle driving assistance program configured to execute at least one of a vehicle moving speed increasing/decreasing control and an inter-vehicle distance increasing/decreasing control,
the vehicle moving speed control corresponding to a control of autonomously moving an own vehicle while alternately increasing and decreasing a vehicle moving speed of the own vehicle within a set vehicle moving speed range, and
the inter-vehicle distance increasing/decreasing control corresponding to a control of autonomously moving the own vehicle while alternately increasing and decreasing an inter-vehicle distance between the own vehicle and another vehicle around the own vehicle within a set inter-vehicle distance range or while alternately increasing and decreasing a period of time required for the own vehicle to move the inter-vehicle distance within a set period-of-time range,
wherein the vehicle driving assistance program is configured to:
while executing the vehicle moving speed increasing/decreasing control, set the set vehicle moving speed range such that the set vehicle moving speed range set when a control range change condition is satisfied, is narrower than the set vehicle moving speed range set when the control range change condition is unsatisfied,
the control range change condition corresponding to a condition that a following vehicle detection device which detects a following vehicle, is malfunctioning; and
while executing the inter-vehicle distance increasing/decreasing control, set the set inter-vehicle distance range or the set period-of-time range such that the set inter-vehicle distance range or the set period-of-time range set when the control range change condition is satisfied, is narrower than the set inter-vehicle distance range or the set period-of-time range set when the control range change condition is unsatisfied.
